(19) United States
(12) Patent Application Publication
(10) Pub. No.: US 2013/0081019 A1
(43) Pub. Date: Mar. 28, 2013

(54) Receiving subtask representations, and obtaining and communicating subtask result data

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/374,518

(22) Filed: Dec. 30, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation-in-part of application No. 13/317,591, filed on Oct. 21, 2011.
Application No. 13/317,591 is a continuation-in-part of application No. 13/317,833, filed on Oct. 28, 2011.
Application No. 13/317,833 is a continuation-in-part of application No. 13/373,795, filed on Nov. 29, 2011.
Application No. 13/373,795 is a continuation-in-part of application No. 13/373,794, filed on Nov. 29, 2011.
Application No. 13/373,794 is a continuation-in-part of application No. 13/373,826, filed on Nov. 30, 2011.
Application No. 13/373,826 is a continuation-in-part of application No. 13/373,829, filed on Nov. 30, 2011.
Application No. 13/373,829 is a continuation of application No. 13/374,511, filed on Dec. 30, 2011.
Application No. 13/374,511 is a continuation-in-part of application No. 13/374,512, filed on Dec. 30, 2011.
Application No. 13/374,512 is a continuation-in-part of application No. 13/374,514, filed on Dec. 30, 2011.
Application No. 13/374,514 is a continuation-in-part of application No. 13/374,529, filed on Dec. 30, 2011.
Application No. 13/374,529 is a continuation-in-part of application No. 13/374,527, filed on Dec. 30, 2011.
Application No. 13/374,527 is a continuation-in-part of application No. 13/374,522, filed on Dec. 30, 2011.
Application No. 13/374,522 is a continuation-in-part of application No. 13/341,901, filed on Dec. 30, 2011.

(51) Int. Cl. G06F 9/46

(52) U.S. Cl. 718/100

(57) ABSTRACT

Computationally implemented methods and systems include receiving one or more representations of one or more subtasks that correspond to at least one portion of at least one task of acquiring data requested by a task requestor, wherein the one or more subtasks are configured to be carried out by at least two discrete interface devices, obtaining subtask result data in an absence of information regarding the at least one task and/or the task requestor, and communicating the result data comprising a result of carrying out the one or more subtasks. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,591, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,833, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,795, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,794, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,826, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,829, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING DISCRETE INTERFACE DEVICE SUBTASK RESULT DATA AND ACQUIRING TASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING DISCRETE INTERFACE DEVICE SUBTASK RESULT DATA AND ACQUIRING TASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to receiving one or more representations of one or more subtasks that correspond to at least one portion of at least one task of acquiring data requested by a task requestor, wherein the one or more subtasks are configured to be carried out by at least two discrete interface devices, obtaining subtask result data in an absence of information regarding the at least one task and/or the task requestor, and communicating the result data comprising a result of carrying out the one or more subtasks. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein- referenced method aspects depending upon the design choices of the system designer.

A computationally implemented system includes, but is not limited to means for receiving one or more representations of one or more subtasks that correspond to at least one portion of at least one task of acquiring data requested by a task requestor, wherein the one or more subtasks are configured to be carried out by at least two discrete interface devices, means for obtaining subtask result data in an absence of information regarding the at least one task and/or the task requestor, and means for communicating the result data comprising a result of carrying out the one or more subtasks. In addition to the foregoing, other system aspects are described in the claims, drawings, and text forming a part of the present disclosure.

A computationally implemented system includes, but is not limited to circuitry for receiving one or more representations of one or more subtasks that correspond to at least one portion of at least one task of acquiring data requested by a task requestor, wherein the one or more subtasks are configured to be carried out by at least two discrete interface devices, circuitry for obtaining subtask result data in an absence of information regarding the at least one task and/or the task requestor, and circuitry for communicating the result data comprising a result of carrying out the one or more subtasks. In addition to the foregoing, other system aspects are described in the claims, drawings, and text forming a part of the present disclosure.

A computer program product comprising an article of manufacture bears instructions including but not limited to one or more instructions for receiving one or more representations of one or more subtasks that correspond to at least one portion of at least one task of acquiring data requested by a task requestor, wherein the one or more subtasks are configured to be carried out by at least two discrete interface devices, one or more instructions for obtaining subtask result data in an absence of information regarding the at least one task and/or the task requestor, and one or more instructions for communicating the result data comprising a result of carrying out the one or more subtasks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2 shows a particular perspective of task requestor task portion subtask data receiving module 52 of module 50 of interface device 20 of environment 100 of FIG. 1.

FIG. 3 shows a particular perspective of absent task and/or task requestor information subtask execution module 54 of module 50 of interface device 20 of environment 100 of FIG. 1.

FIG. 4 shows a particular perspective of the subtask result data transmitting module 56 of module 50 of interface device 20 of environment 100 of FIG. 1.

FIG. 5 is a high-level logic flowchart of a process, e.g., operational flow 500, according to an embodiment.

FIG. 6A is a high-level logic flowchart of a process depicting alternate implementations of a receiving one or more representations of one or more subtasks that correspond to at least one portion of at least one task requested by a task requestor operation 502 of FIG. 5.

FIG. 6B is a high-level logic flowchart of a process depicting alternate implementations of a receiving one or more representations of one or more subtasks that correspond to at least one portion of at least one task requested by a task requestor operation 502 of FIG. 5.

FIG. 6C is a high-level logic flowchart of a process depicting alternate implementations of a receiving one or more representations of one or more subtasks that correspond to at least one portion of at least one task requested by a task requestor operation 502 of FIG. 5.

FIG. 6D is a high-level logic flowchart of a process depicting alternate implementations of a receiving one or more representations of one or more subtasks that correspond to at least one portion of at least one task requested by a task requestor operation 502 of FIG. 5.

FIG. 6E is a high-level logic flowchart of a process depicting alternate implementations of a receiving one or more representations of one or more subtasks that correspond to at least one portion of at least one task requested by a task requestor operation 502 of FIG. 5.

FIG. 6F is a high-level logic flowchart of a process depicting alternate implementations of a receiving one or more representations of one or more subtasks that correspond to at least one portion of at least one task requested by a task requestor operation 502 of FIG. 5.

FIG. 6G is a high-level logic flowchart of a process depicting alternate implementations of a receiving one or more representations of one or more subtasks that correspond to at least one portion of at least one task requested by a task requestor operation 502 of FIG. 5.

FIG. 7A is a high-level logic flowchart of a process depicting alternate implementations of an obtaining subtask result data in an absence of information regarding the at least one task and/or the task requestor operation 504

FIG. 7B is a high-level logic flowchart of a process depicting alternate implementations of an obtaining subtask result data in an absence of information regarding the at least one task and/or the task requestor operation 504

FIG. 7C is a high-level logic flowchart of a process depicting alternate implementations of an obtaining subtask result data in an absence of information regarding the at least one task and/or the task requestor operation 504

FIG. 7D is a high-level logic flowchart of a process depicting alternate implementations of an obtaining subtask result data in an absence of information regarding the at least one task and/or the task requestor operation 504

FIG. 8A is a high-level logic flowchart of a process depicting alternate implementations of a communicating the result data comprising a result of carrying out the one or more subtasks operation 506 of FIG. 5.

FIG. 8B is a high-level logic flowchart of a process depicting alternate implementations of a communicating the result data comprising a result of carrying out the one or more subtasks operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries that do not contain a large number of portable computing devices at any given time. These portable computing devices are constantly collecting data, and capable of collecting data, which is not stored in any repository or transmitted to any device that may use such data. Thus, such data, and opportunity to collect data, may be lost.

In accordance with various embodiments, computationally implemented methods, systems, and articles of manufacture are provided for Error! Reference source not found., Error! Reference source not found., Error! Reference source not found., and Error! Reference source not found.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

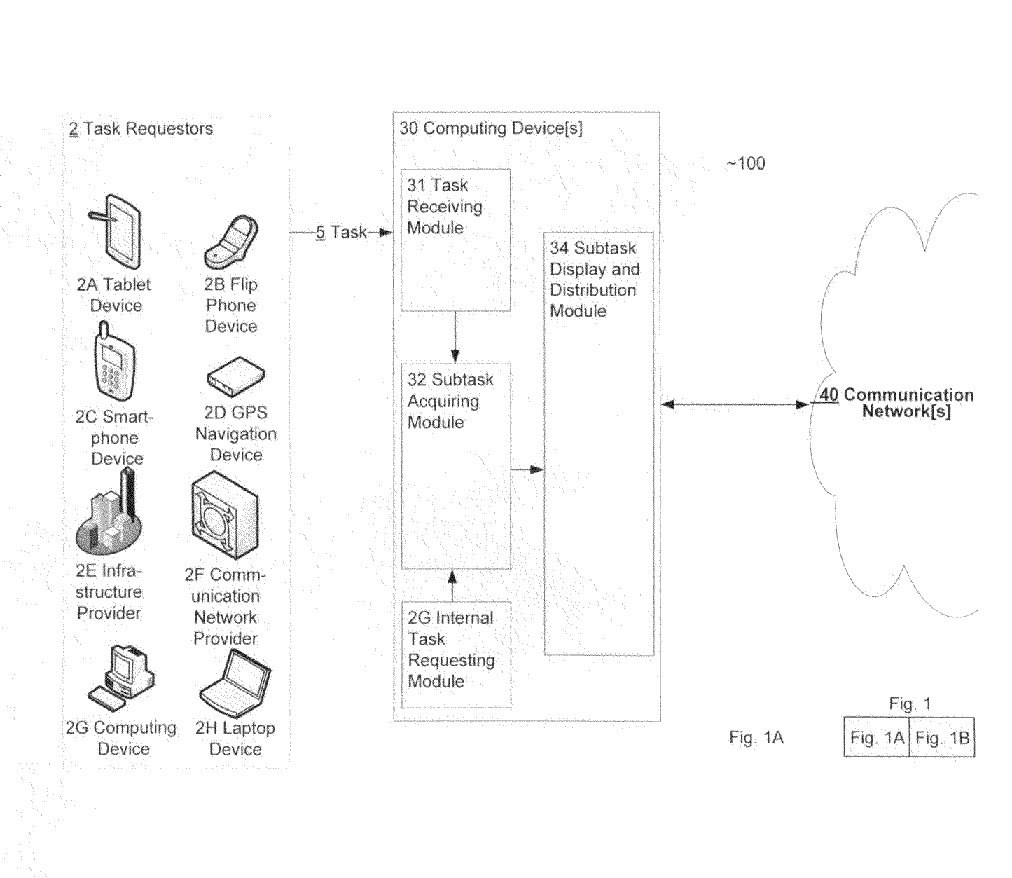

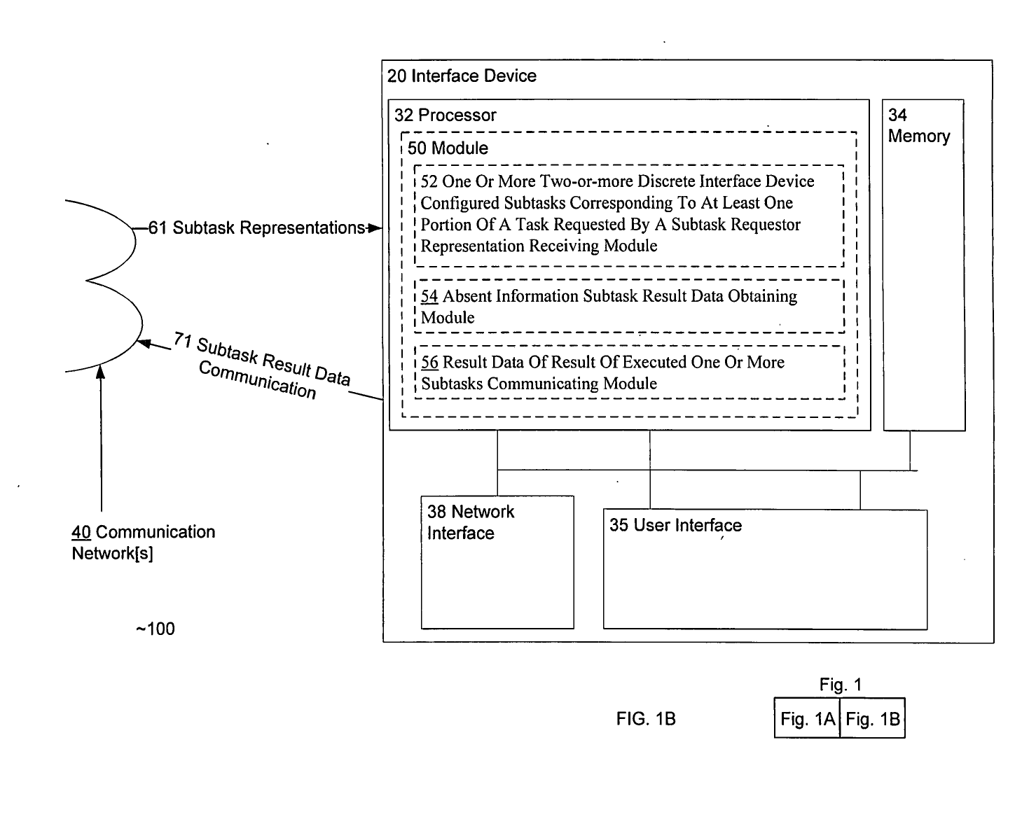

Referring now to FIG. 1, FIG. 1 illustrates an interface device 20 in an exemplary environment 100. As will be described in more detail herein, the interface device 20 may employ the computationally implemented methods, systems, and articles of manufacture in accordance with various embodiments. The interface device 20, in various embodiments, may be endowed with logic that is designed to receive subtask data including one or more subtasks that correspond to at least one portion of at least one task requested by a task requestor, wherein the one or more subtasks are configured to be carried out by two or more discrete interface devices, carry out the one or more subtasks in an absence of information regarding the at least one task and/or the task requestor, and transmit result data comprising a result of carrying out the one or more subtasks.

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, and internal task requesting module 2G, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules which will be discussed in more detail herein. Specifically, these particular modules may be implemented across different networks and systems, and may be partially or wholly unaware of each other, except for the need to transmit data as indicated by the arrows within computing device 30.

A task 5 sent from a task requestor 2 may be received by task receiving module 31. Task receiving module 31 then may pass the task to subtask acquiring module 32, where the task is separated into component subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

Subtask acquiring module 32 may then pass the acquired subtasks to a subtask display and distribution module. Subtask display and distribution module may distribute the subtasks to at least two interface devices 20. The subtasks are designed to be carried out by two or more discrete interface devices 20. Nevertheless, for ease of illustration, only one discrete interface device 20 is shown in FIG. 1. Discrete interface device 20 and subtask display and distribution module 34 communicate via a communication network 40.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other.

It is noted that discrete interface device 20 communicates only with subtask display and distribution module 34. Discrete interface device 20 is not provided with any information regarding the task requestor 2, or even the task 5 received by the task receiving module prior to being broken into component subtasks. This is true even when, as with task requestor 2G, the task request may be internal to computing device 30. Regardless of the situation or orientation of the task requestors 2, or whether subtask acquiring module and task receiving module are internal or external to computing device 30, interface device 20 receives only the subtask information from the subtask display and distribution module 34 of the computing device 30.

Specifically, as shown in the exemplary embodiment 100 of FIG. 1, interface device 20 may receive subtask representations 61, which may include subtask data. In some embodiments, the subtask data may be received separately (not shown) from the subtask representations 61. The interface device 20 also may communicate the result data comprising a result of carrying out the one or more subtasks 71. Such communication is with computing device 30 and does not extend directly to the task requestors 2*.

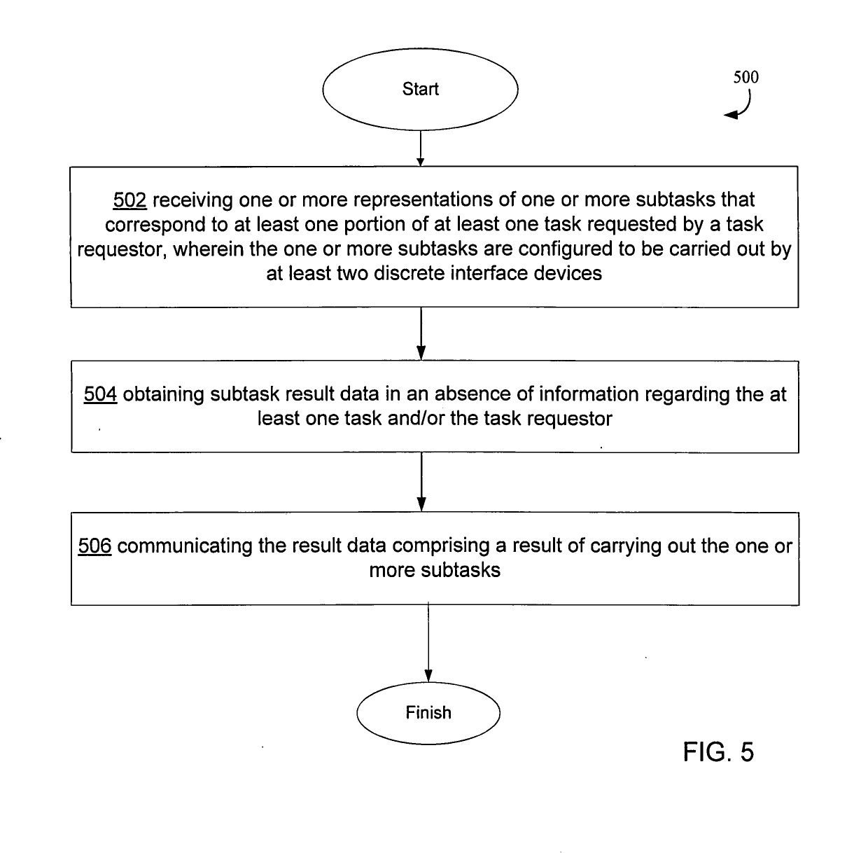

Referring again to the example environment 100 of FIG. 1, in various embodiments, the interface device 20 may comprise, among other elements, a processor 32, a memory 34, a network interface 38, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5D, 6A-6H, and 7. In some embodiments, processor 32 is designed to be configured to operate as the subtask module 50 which may include task requestor task portion subtask data receiving module 52, absent task and/or task requestor information subtask execution module 54, and subtask result data transmitting module 56.

As described above, the discrete interface device 20 may comprise a memory 34. In some embodiments, depending on the complexity of the interface device 20. memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other. The memory 34 is an optional portion of interface device 20.

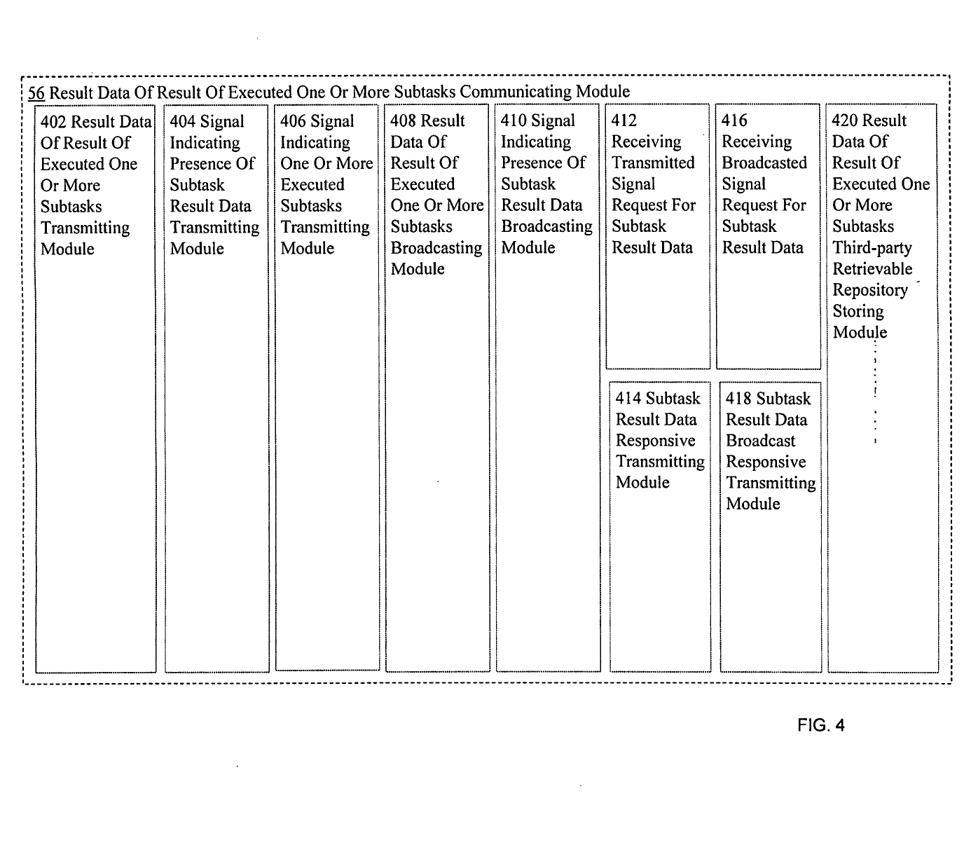

As described above, and with reference to FIG. 1, computing device 20 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user. The user interface 35 also is an optional portion of interface device 20. It is noted that, in some embodiments, a “user” is a representation of a person operating an electronic device, e.g., a portable computing device, or a non-portable computing device, e.g., a desktop computer, an information kiosk, or a terminal, e.g., an ATM terminal. In other embodiments, however, a user is merely a representation of a machine or person making a request. For example, a user may be an automated program that carries out tasks. As will be further described with reference to FIG. 4, the operational flow 400 may be executed in a variety of different ways in various alternative implementations, which will be discussed in more detail herein.

Referring again to FIG. 1, interface device 20 may include a network interface 38. Communications between the interface device 20 and the communications network 40 may be facilitated by the network interface module 38, which may be implemented as hardware or software, or both, used to interface the interface device 20 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

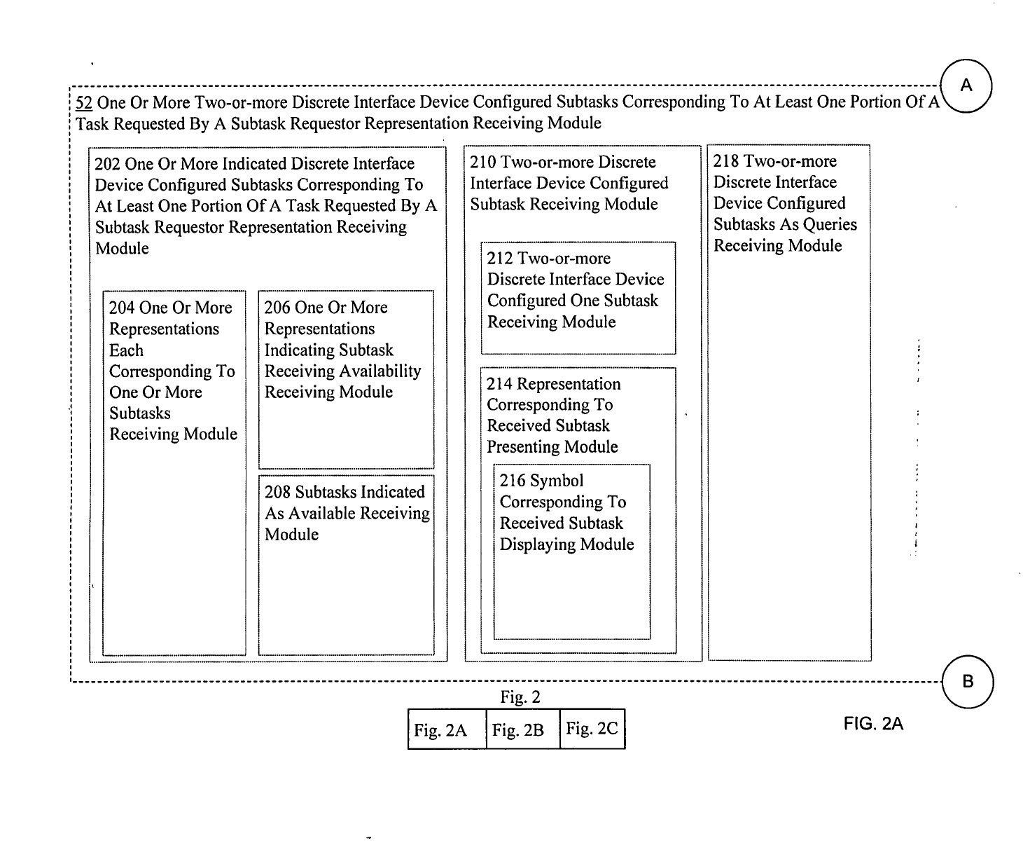

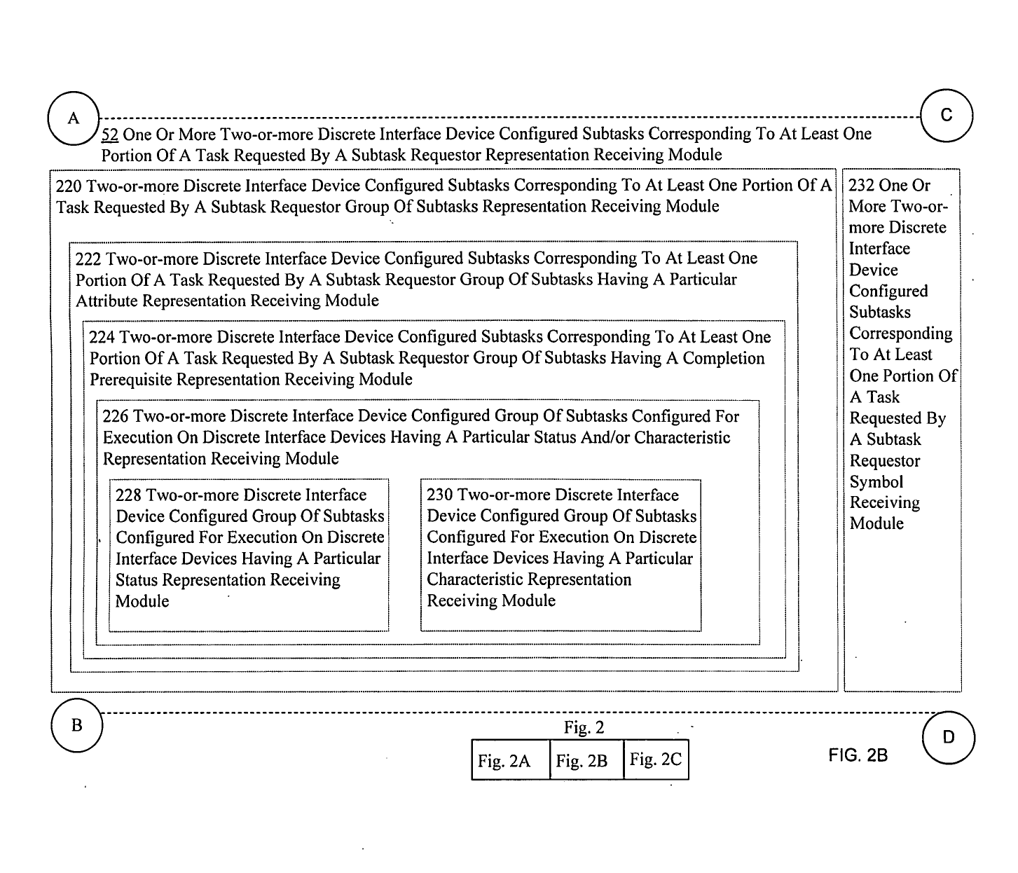

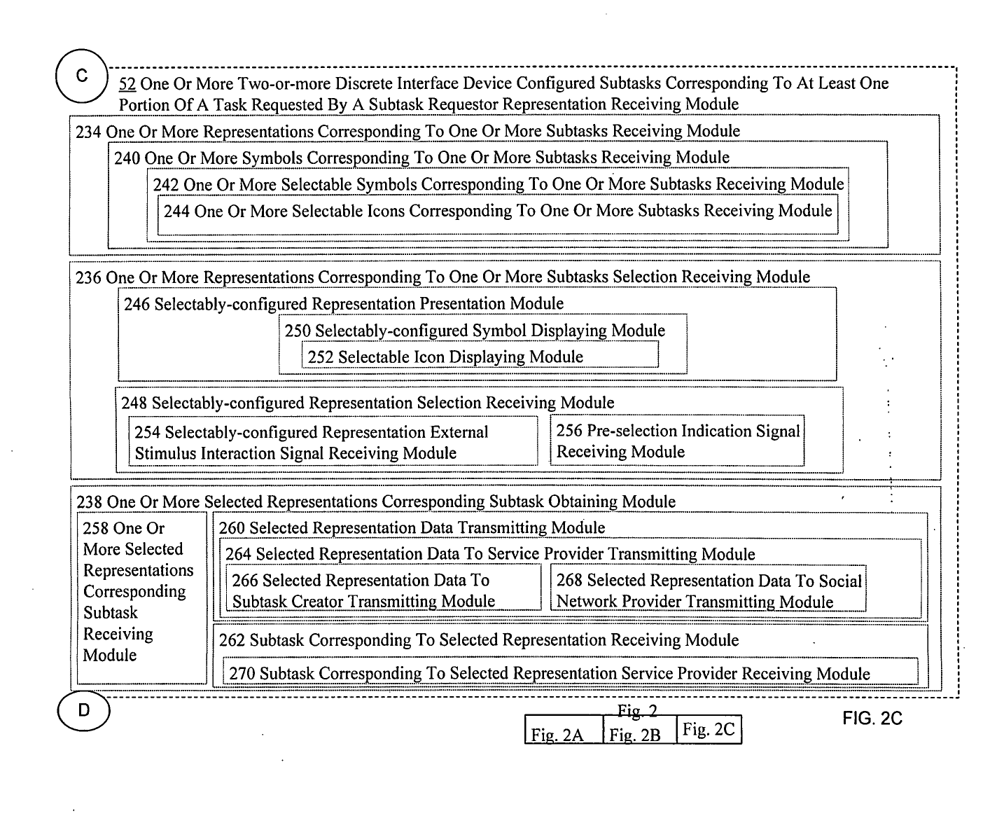

Referring now to FIG. 2, FIG. 2 illustrates an exemplary implementation of the one or more two-or-more discrete interface device configured subtasks corresponding to at least one portion of a task requested by a subtask requestor representation receiving module 52 of module 50. As illustrated in FIG. 2, module 52 may include one or more sub-logic modules in various alternative implementations. These modules will be discussed in more detail herein with respect to the corresponding methods carried out by the logic and sub-logic modules.

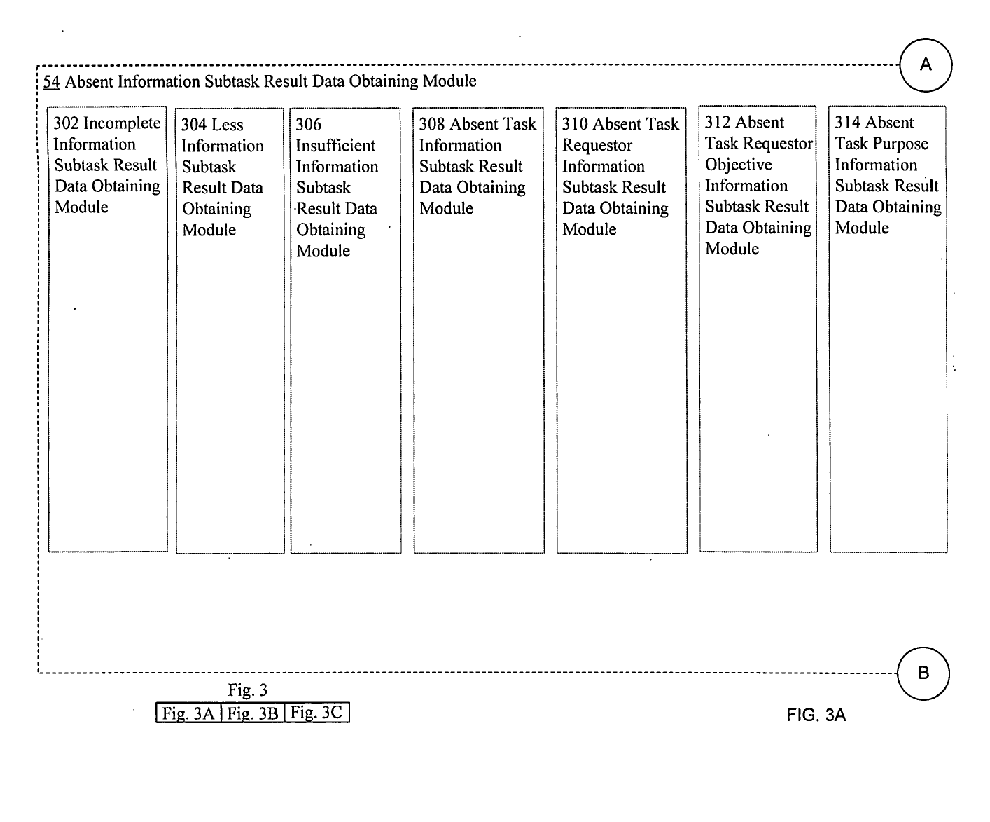

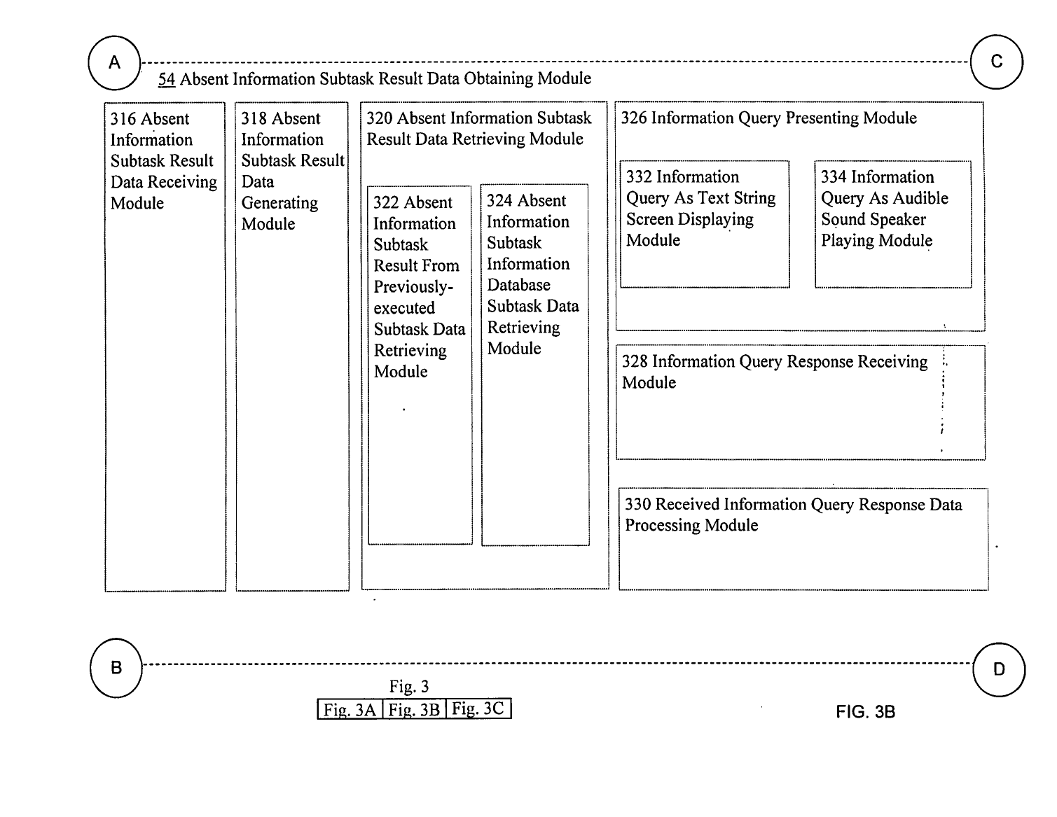

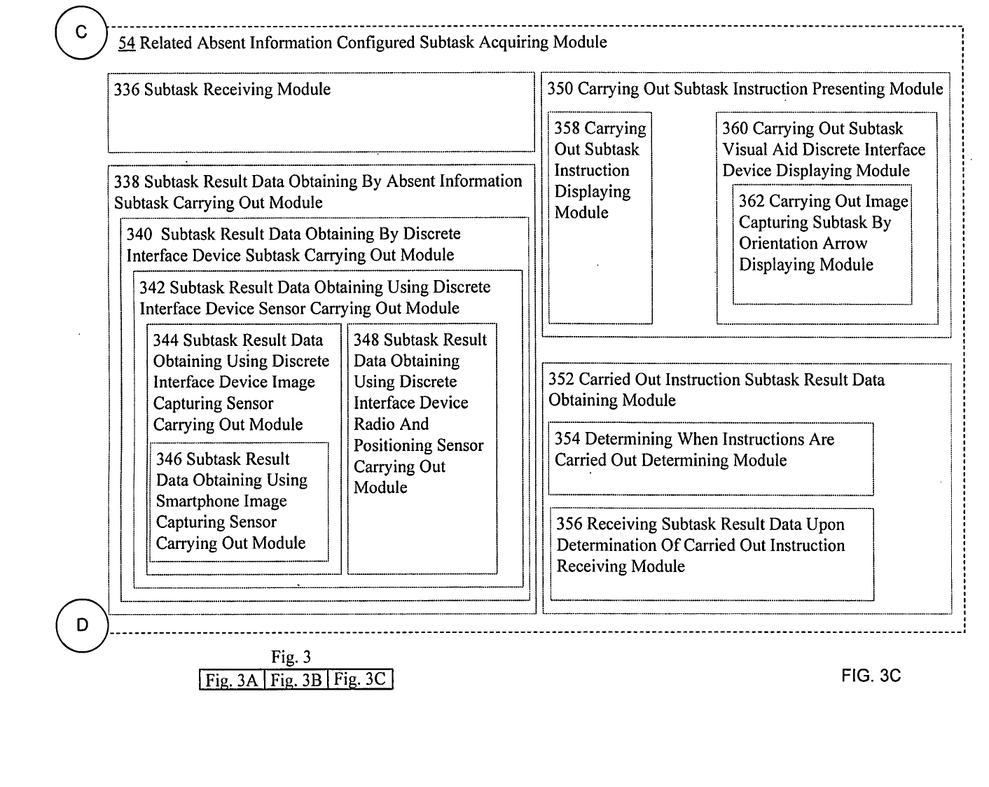

Referring now to FIG. 3, FIG. 3 illustrates an exemplary implementation of the absent information subtask result data obtaining module 54 of module 50. As illustrated in FIG. 3, module 54 may include one or more sub-logic modules in various alternative implementations. These modules will be discussed in more detail herein with respect to the corresponding methods carried out by the logic and sub-logic modules.

Referring now to FIG. 4, FIG. 4 illustrates an exemplary implementation of the result data of result of executed one or more subtasks communicating module 56 of module 50. As illustrated in FIG. 4, module 56 may include one or more sub-logic modules in various alternative implementations. These modules will be discussed in more detail herein with respect to the corresponding methods carried out by the logic and sub-logic modules.

A more detailed discussion related interface device 20 of FIG. 1 will now be provided with respect to the processes and operations to be described herein. FIG. 5 illustrates an operational flow 500 representing example operations for, among other methods receiving one or more representations of one or more subtasks that correspond to at least one portion of at least one task of acquiring data requested by a task requestor, wherein the one or more subtasks are configured to be carried out by at least two discrete interface devices, obtaining subtask result data in an absence of information regarding the at least one task and/or the task requestor, and communicating the result data comprising a result of carrying out the one or more subtasks.

In FIG. 5 and in the following figures that include various examples of operational flows, discussions and explanations will be provided with respect to the exemplary environment 100 as described above and as illustrated in FIG. 1, and with respect to other examples (e.g., as provided in FIGS. 2-4) and contexts. It should be understood that the operational flows may be executed in a number of other environments and contexts, and/or in modified versions of the systems shown in FIGS. 2-4. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Referring again to FIG. 5, a computationally implemented method includes, but is not limited to receiving one or more representations of one or more subtasks that correspond to at least one portion of at least one task of acquiring data requested by a task requestor, wherein the one or more subtasks are configured to be carried out by at least two discrete interface devices, obtaining subtask result data in an absence of information regarding the at least one task and/or the task requestor, and communicating the result data comprising a result of carrying out the one or more subtasks. In addition to the foregoing, other method aspects are described in the claims, drawings, and text forming a part of the present disclosure.

Referring again to FIG. 5, FIG. 5 shows operation 500 that may include operation 502 depicting receiving one or more representations of one or more subtasks that correspond to at least one portion of at least one task of acquiring data requested by a task requestor, wherein the one or more subtasks are configured to be carried out by at least two discrete interface devices. For example, FIG. 1 shows one or more two-or-more discrete interface device configured subtasks corresponding to at least one portion of a task requested by a subtask requestor representation receiving module 52 receiving one or more representations (e.g., symbols, either visual or otherwise, e.g., icons) of one or more subtasks (e.g., “capture image data of Times Square from your location at 12 midnight on New Years' Eve”) that correspond to at least one portion of at least one task (e.g., “obtain a near-real time 360 degree picture of Times Square at midnight on New Years' Eve”) requested by a task requestor (e.g., a discrete interface device, or a user, or a company, or a machine, or any entity that requests a task), wherein the one or more subtasks (e.g., “capture image data of Times Square from your location at 12 midnight on New Years' Eve”) are configured to be carried out by at least two discrete interface devices (e.g., interface devices that are separate machines, e.g., a laptop and a cell phone, or a tablet and a smartphone, or two of the same smartphone operated by different people).

Referring again to FIG. 5, FIG. 5 shows operation 500 that may include operation 504 depicting obtaining subtask result data in an absence of information regarding the at least one task and/or the task requestor. For example, FIG. 1 shows absent information subtask result data obtaining module 54 obtaining subtask result data (e.g., carrying out the subtask, or retrieving previously carried out subtask result data of a subtask, (e.g., “capture image data of Times Square from your location at 12 midnight on New Years' Eve”)) in an absence of information regarding the task and/or the task requestor (e.g., the two or more discrete interface devices carry out the subtask with an absence of (e.g., less, incomplete, missing, or withheld) information regarding at least one of the task and the task requestor).

Referring again to FIG. 5, FIG. 5 shows operation 500 that may include operation 506 depicting communicating the result data comprising a result of carrying out the one or more subtasks. For example, FIG. 1 shows result data of result of executed one or more subtasks communicating module 56 communicating (e.g., transmitting or facilitating the transmission of) the result data (e.g., image data) comprising a result of carrying out the one or more subtasks (e.g., “capture image data of Times Square from your location at 12 midnight on New Years' Eve”).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

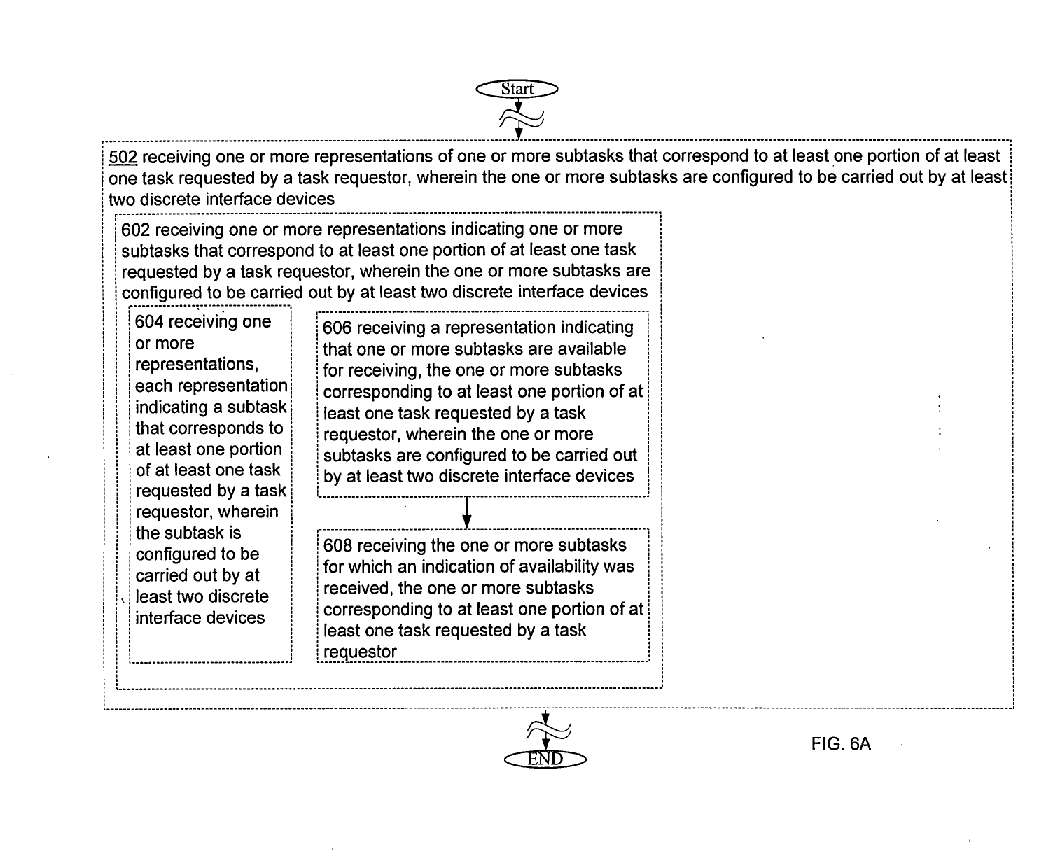

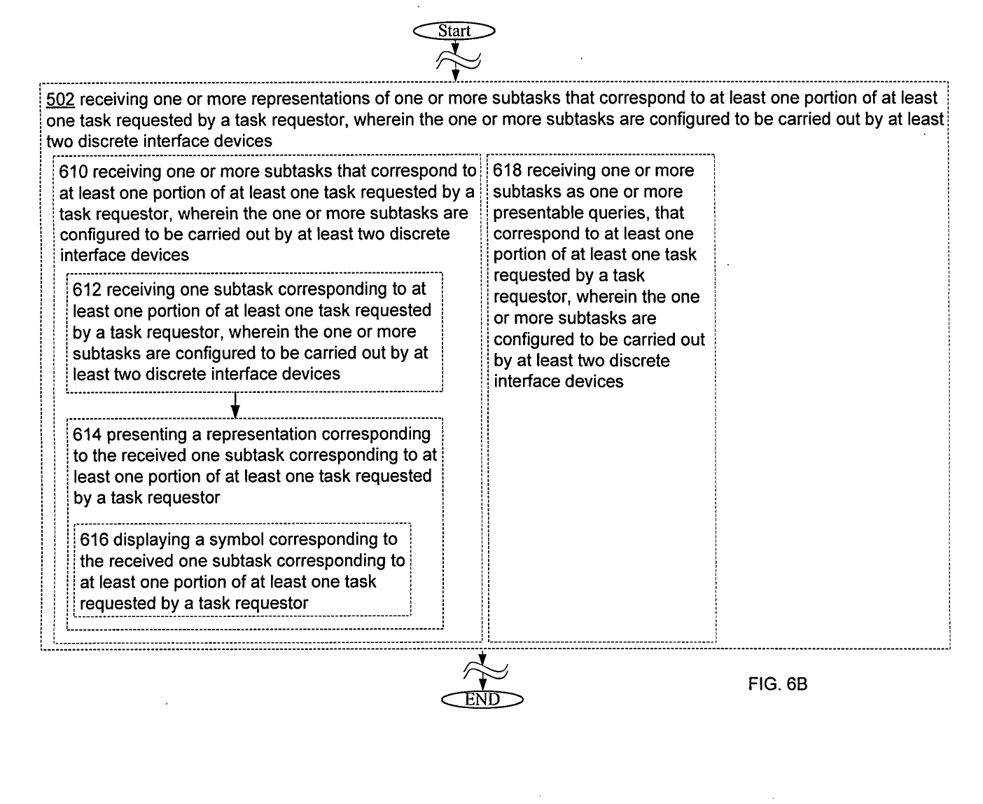

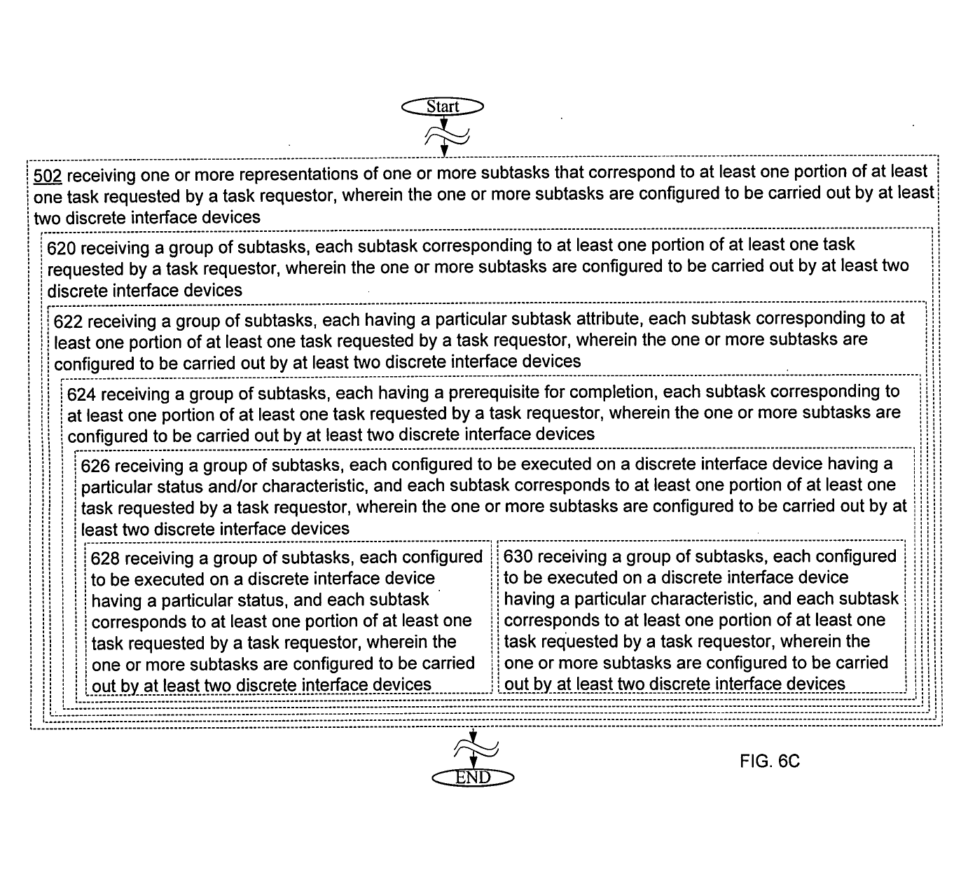

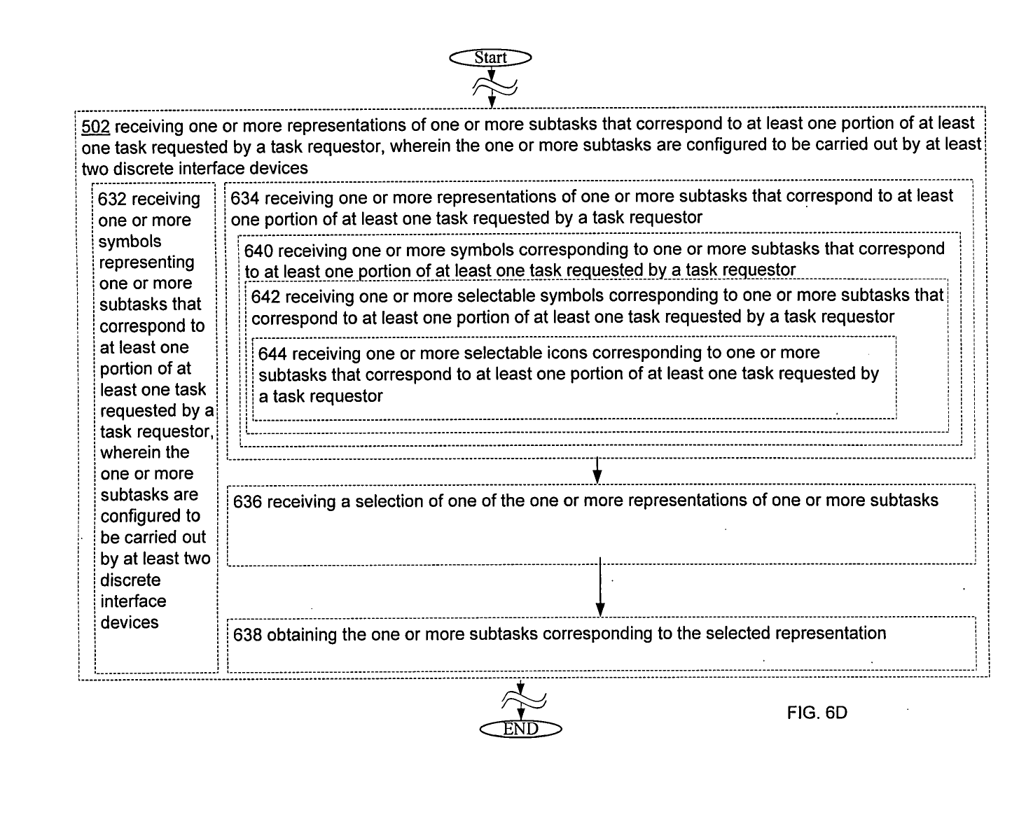

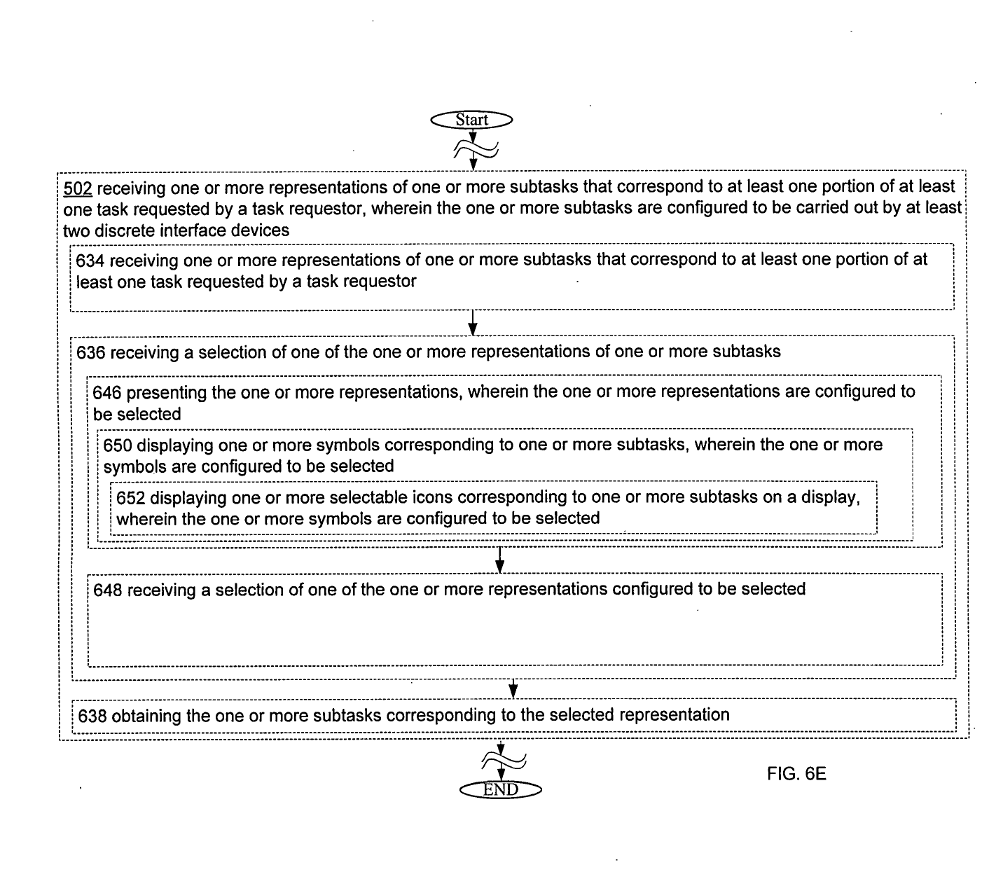

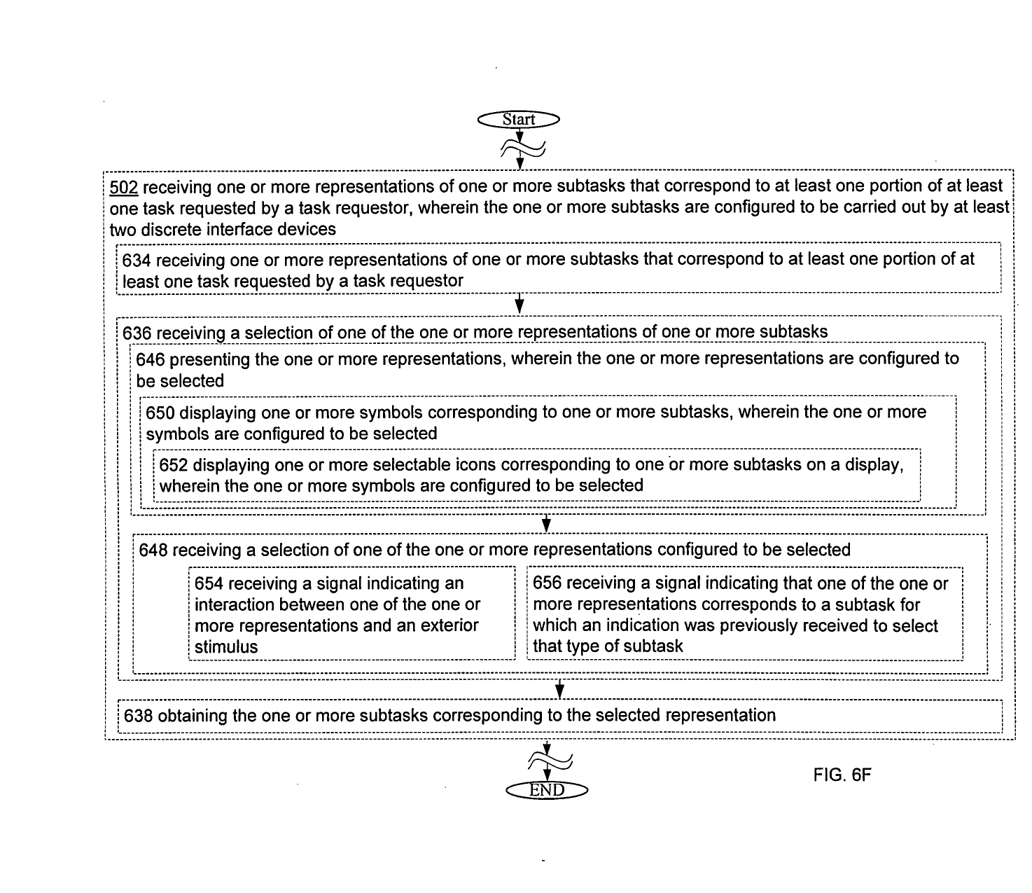

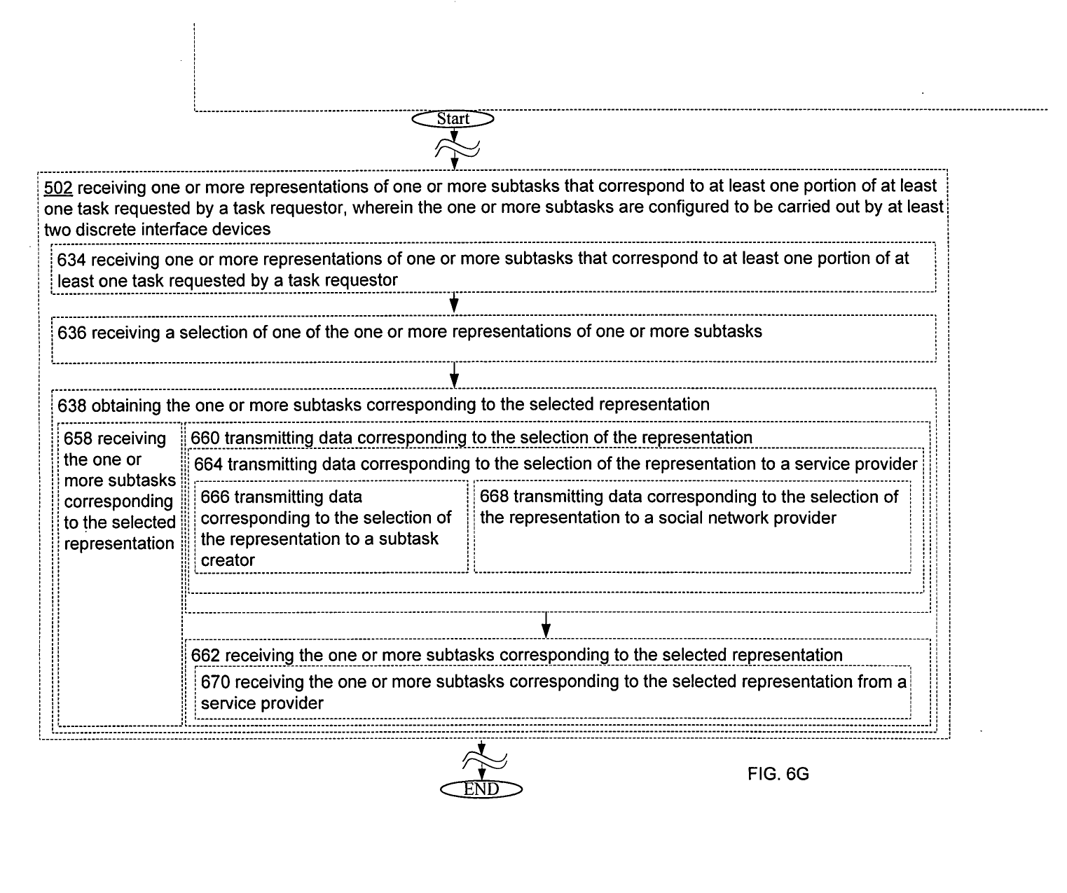

FIGS. 6A-6G depict various implementations of operation 502, according to embodiments. Referring now to FIG. 6, operation 502 may include operation 602 depicting receiving one or more representations indicating one or more subtasks that correspond to at least one portion of at least one task requested by a task requestor, wherein the one or more subtasks are configured to be carried out by at least two discrete interface devices. For example, FIG. 2 shows one or more indicated discrete interface device configured subtasks corresponding to at least one portion of a task requested by a subtask requestor representation receiving module 202 receiving one or more representations (e.g., symbols or icons) indicating one or more subtasks (e.g., “capture an image of the stage at Merriweather Post Pavilion from your seat”) that correspond to at least one portion of at least one task (e.g., “determine which seat at Merriweather Post Pavilion has an unobstructed view of the stage for the U2 concert”), wherein the one or more tasks are configured to be carried out by at least two discrete interface devices (e.g., two Apple iPhone 4s).

Referring again to FIG. 6A, operation 602 may include operation 604 depicting receiving one or more representations, each representation indicating a subtask that corresponds to at least one portion of at least one task requested by a task requestor, wherein each indicated subtask is configured to be carried out by at least two discrete interface devices. For example, FIG. 2 shows one or more representations each corresponding to one or more subtasks receiving module 204 receiving one or more representations (e.g., icons with text), each representation (e.g., a musical note icon with the words “measure loudness”) indicating a subtask (e.g., “determine the loudness of the U2 concert at Merriweather Post Pavilion from your seat”) that corresponds to at least one portion of at least one task (e.g., “determine the loudest seat for the U2 concert at Merriweather Post Pavilion”) requested by a task requestor, wherein each indicated subtask is configured to be carried out by at least two discrete interface devices.

Referring again to FIG. 6A, operation 602 may include operation 606 depicting receiving a representation indicating that one or more subtasks are available for receiving, the one or more subtasks corresponding to at least one portion of at least one task requested by a task requestor, wherein the one or more subtasks are configured to be carried out by at least two discrete interface devices. For example, FIG. 2 shows one or more representations indicating subtask receiving availability receiving module 206 receiving a representation (e.g., an icon of a speedometer) indicating that one or more subtasks (e.g., “measure speed you are currently traveling on I-90”) are available for receiving (e.g., the subtask of “measure speed you are currently traveling on I-90” is ready to be received, but only the representation has been received so far) corresponding to at least one portion of at least one task (e.g., “determine how bad traffic is on the south branch of I-90”) requested by a task requestor, wherein the one or more subtasks are configured to be carried out by at least two discrete interface devices (e.g., a TomTom GPS and a Garmin Nuvi GPS device).

Referring again to FIG. 6A, in embodiments in which operation 602 includes operation 606, operation 602 also may include operation 608 depicting receiving the one or more subtasks for which an indication of availability was received, the one or more subtasks corresponding to at least one portion of at least one task requested by a task requestor. For example, FIG. 2 shows subtasks indicated as available receiving module 208 receiving the one or more subtasks (e.g., measure speed you are currently traveling on I-90″) for which an indication of availability (e.g., the icon of the speedometer) was received, the one or more subtasks corresponding to at least one portion of at least one task (e.g., “determine how bad traffic is on the south branch of I-90”) requested by a task requestor.

Referring now to FIG. 6B, operation 502 may include operation 610 depicting receiving one or more subtasks that correspond to at least one portion of at least one task requested by a task requestor, wherein the one or more subtasks are configured to be carried out by at least two discrete interface devices. For example, FIG. 2 shows two-or-more discrete interface device configured subtask receiving module 210 receiving one or more subtasks (e.g., “determine the 4G network upload speed at your current location”) that correspond to at least one portion of at least one task (e.g., “determine which coffee shop in Clarendon, Va., have the fastest 4G upload speeds”) requested by a task requestor (e.g., Verizon Wireless), wherein the one or more subtasks are configured to be carried out by at least two discrete interface devices (e.g., an Apple iPhone 4 and a Samsung Galaxy S II).

Referring again to FIG. 6B, operation 610 may include operation 612 depicting receiving one subtask corresponding to at least one portion of at least one task requested by a task requestor, wherein the one or more subtasks are configured to be carried out by at least two discrete interface devices. For example, FIG. 2 shows two-or-more discrete interface device configured one subtask receiving module 212 receiving one subtask (e.g., “determine how many unencrypted wireless networks are visible from your current location”) corresponding to at least one portion of at least one task (e.g., “determine which coffee shop in DuPont Circle has the largest wireless network coverage”) requested by a task requestor (e.g., a user of an interface device in a different neighborhood in Washington, D.C.), wherein the one or more subtasks are configured to be carried out by at least two discrete interface devices (e.g., an Apple iPhone 4 and a Samsung Galaxy S II).

Referring again to FIG. 6B, in embodiments in which operation 610 includes operation 612, operation 610 also may include operation 614 depicting presenting a representation corresponding to the received one subtask corresponding to at least one portion of at least one task requested by a task requestor. For example, FIG. 2 shows representation corresponding to received subtask presenting module 214 presenting (e.g., expressing to a user) a representation (e.g., a sensory depiction) corresponding to the received one subtask (e.g., “determine how many unencrypted wireless networks are visible from your current location”) corresponding to at least one portion of at least one task (e.g., “determine which coffee shop in DuPont Circle has the largest wireless network coverage”) requested by a task requestor (e.g., a user of an interface device in a different neighborhood in Washington, D.C.).

Referring again to FIG. 6B, operation 614 may include operation 616 depicting displaying a symbol corresponding to the received one subtask corresponding to at least one portion of at least one task requested by a task requestor. For example, FIG. 2 shows symbol corresponding to received subtask displaying module 216 displaying a symbol (e.g., a coffee icon with small lightning bolts extending away, indicating data transfer) corresponding to the received one subtask (e.g., “determine the strength of the strongest unencrypted wireless network at your current location”) corresponding to at least one portion of at least one task (e.g., “determine which coffee shop in DuPont Circle has the strongest wireless network for watching YouTube videos at the coffee shop”) requested by a task requestor (e.g., a user of an interface device in a different neighborhood in Washington, D.C.).

Referring again to FIG. 6B, operation 502 may include operation 618 depicting receiving one or more subtasks as one or more presentable queries, that correspond to at least one portion of at least one task requested by a task requestor, wherein the one or more subtasks are configured to be carried out by at least two discrete interface devices. For example, FIG. 2 shows two-or-more discrete interface device configured subtasks as queries receiving module 218 receiving one or more subtasks (“determine the freshness of the bagels at the coffee shop at your location”) as one or more presentable (e.g., displayable on a screen or playable through a speaker) queries (e.g., “rate, on a scale of 1 to 10, the freshness of the bagel at the coffee shop at which you are located”), that correspond to at least one portion of at least one task (e.g., determine which coffee shop in Old Town, Alexandria, has the best baked goods) requested by a task requestor (e.g., Big Apple Tasty Bagel Co.), wherein the one or more subtasks are configured to be carried out by at least two discrete interface devices (e.g., T-Mobile MyTouch and an Acer Iconia A500).

Referring now to FIG. 6C, operation 502 may include operation 620 depicting receiving a group of subtasks, each subtask corresponding to at least one portion of at least one task requested by a task requestor, wherein the one or more subtasks are configured to be carried out by at least two discrete interface devices. For example, FIG. 2 shows two-or-more discrete interface device configured subtasks corresponding to at least one portion of a task requested by a subtask requestor group of subtasks representation receiving module 220 receiving a group of subtasks (e.g., “capture an image of the stage from your seat at the Merriweather Post Pavilion,” “detect the loudness of the band at 9 pm from your seat at the Merriweather Post Pavilion,” “answer a query regarding the crowdedness of your row at the Pearl Jam concert at Merriweather Post Pavilion”), each subtask corresponding to at least one portion of at least one task requested by a task requestor, wherein the one or more subtasks are configured to be carried out by at least two discrete interface devices (e.g., a Motorola Droid Razr and a BlackBerry Torch).

Referring again to FIG. 6C, operation 620 may include operation 622 depicting receiving a group of subtasks, each having a particular subtask attribute, each subtask corresponding to at least one portion of at least one task requested by a task requestor, wherein the one or more subtasks are configured to be carried out by at least two discrete interface devices. For example, FIG. 2 shows two-or-more discrete interface device configured subtasks corresponding to at least one portion of a task requested by a subtask requestor group of subtasks having a particular attribute representation receiving module 222 receiving a group of subtasks (e.g., “capture an image of the stage from your seat at the Merriweather Post Pavilion,” “detect the loudness of the band at 9 pm from your seat at the Merriweather Post Pavilion,” “answer a query regarding the crowdedness of your row at the Pearl Jam concert at Merriweather Post Pavilion”), each having a particular subtask attribute (e.g., each subtask may be performed by discrete interface devices positioned at Merriweather Post Pavilion), each subtask corresponding to at least one portion of at least one task requested by a task requestor, wherein the one or more subtasks are configured to be carried out by at least two discrete interface devices (e.g., the Samsung Focus S and the Sony Ericsson Xperia).

Referring again to FIG. 6C, operation 622 may include operation 624 depicting receiving a group of subtasks, each having a prerequisite for completion, each subtask corresponding to at least one portion of at least one task requested by a task requestor, wherein the one or more subtasks are configured to be carried out by at least two discrete interface devices. For example, FIG. 2 shows two-or-more discrete interface device configured subtasks corresponding to at least one portion of a task requested by a subtask requestor group of subtasks having a completion prerequisite representation receiving module 224 receiving a group of subtasks (e.g., “take a picture of Times Square from your location,” “take a picture of the Empire State building,” “go to the nearest coffee shop and hold your phone outward, and activate the image capturing sensor”), each having a prerequisite for completion (e.g., requiring an image capturing sensor), each subtask corresponding to at least one portion of at least one task requested by a task requestor, wherein the one or more subtasks are configured to be carried out by at least two discrete interface devices (e.g., the Apple iPad 2 and the Motorola Xoom).

Referring again to FIG. 6C, operation 624 may include operation 626 depicting receiving a group of subtasks, each configured to be executed on a discrete interface device having a particular status and/or characteristic, and each subtask corresponds to at least one portion of at least one task requested by a task requestor, wherein the one or more subtasks are configured to be carried out by at least two discrete interface devices. For example, FIG. 2 shows two-or-more discrete interface device configured group of subtasks configured for execution on discrete interface devices having a particular status and/or characteristic representation receiving module 226 receiving a group of subtasks (e.g., “capture an image of the stage from your seat at the Merriweather Post Pavilion,” “detect the loudness of the band at 9 pm from your seat at the Merriweather Post Pavilion,” “answer a query regarding the crowdedness of your row at the Pearl Jam concert at Merriweather Post Pavilion”), each configured to be executed on a discrete interface devices having a particular status and/or characteristic (e.g., “located at Merriweather Post Pavilion”), and each subtask corresponds to at least one portion of at least one task requested by a task requestor, wherein the one or more subtasks are configured to be carried out by at least two discrete interface devices (e.g., the Nokia Lumia and the Kyocera Duracore).

Referring again to FIG. 6C, operation 626 may include operation 628 depicting receiving a group of subtasks, each configured to be executed on a discrete interface device having a particular status, and each subtask corresponding to at least one portion of at least one task requested by a task requestor, wherein the one or more subtasks are configured to be carried out by at least two discrete interface devices. For example, FIG. 2 shows two-or-more discrete interface device configured group of subtasks configured for execution on discrete interface devices having a particular status representation receiving module 228 receiving a group of subtasks (e.g., “capture an image of the stage from your seat at the Merriweather Post Pavilion,” “detect the loudness of the band at 9 pm from your seat at the Merriweather Post Pavilion,” “answer a query regarding the crowdedness of your row at the Pearl Jam concert at Merriweather Post Pavilion”), each configured to be executed on a discrete interface devices having a particular status (e.g., “located at Merriweather Post Pavilion”), and each subtask corresponds to at least one portion of at least one task requested by a task requestor, wherein the one or more subtasks are configured to be carried out by at least two discrete interface devices (e.g., the Nokia Lumia and the Kyocera Duracore).

Referring again to FIG. 6C, operation 626 may include operation 630 depicting receiving a group of subtasks, each configured to be executed on a discrete interface device having a particular characteristic, and each subtask corresponding to at least one portion of at least one task requested by a task requestor, wherein the one or more subtasks are configured to be carried out by at least two discrete interface devices. For example, FIG. 2 shows two-or-more discrete interface device configured group of subtasks configured for execution on discrete interface devices having a particular characteristic representation receiving module 230 receiving a group of subtasks (e.g., “take a picture of Times Square from your location,” “take a picture of the Empire State building,” “go to the nearest coffee shop and hold your phone outward, and activate the image capturing sensor”), each configured to be executed on a discrete interface device having a particular characteristic (e.g., “has an image capturing sensor”), and each subtask corresponding to at least one portion of at least one task requested by a task requestor, wherein the one or more subtasks are configured to be carried out by at least two discrete interface devices.

Referring now to FIG. 6D, operation 502 may include operation 632 depicting receiving one or more symbols representing one or more subtasks that correspond to at least one portion of at least one task requested by a task requestor, wherein the one or more subtasks are configured to be carried out by at least two discrete interface devices. For example, FIG. 2 shows one or more two-or-more discrete interface device configured subtasks corresponding to at least one portion of a task requested by a subtask requestor symbol receiving module 232 receiving one or more symbols (e.g., icons, e.g., an icon of a sun shining through a window) representing one or more subtasks (e.g., “determine how much sunlight the apartment at your present location receives in the morning”) that correspond to at least one portion of at least one task (e.g., “determine how much sunlight east-facing apartments on South Street get in the mornings”), wherein the one or more subtasks are configured to be carried out by at least two discrete interface devices (e.g., Dell Inspiron 15 and Motorola Xoom).

Referring again to FIG. 6D, operation 502 may include operation 634 depicting receiving one or more representations of one or more subtasks that correspond to at least one portion of at least one task requested by a task requestor. For example, FIG. 2 shows one or more representations corresponding to one or more subtasks receiving module 234 receiving one or more representations (e.g., icons) of one or more subtasks (e.g., “determine how fast you are moving across the I-90 bridge at your location”) that correspond to at least one portion of at least one task (e.g. “determine traffic levels for I-90 from Seattle to Bellevue right now”) requested by a task requestor.

Referring again to FIG. 6D, operation 502 may further include operation 636 depicting receiving a selection of one of the one or more representations of one or more subtasks. For example, FIG. 2 shows one or more representations corresponding to one or more subtasks selection receiving module 236 receiving a selection (e.g., receiving a user input to select one of the icons, e.g., with a finger on a touchscreen, or with a mouse or other pointing device, or, e.g., receiving a voice command indicating selection of a representation) of one of the one or more representations (e.g., one of the icons, e.g., a baseball icon) of one or more subtasks (e.g., “determine the view from your location at Safeco field”).

Referring again to FIG. 6D, operation 502 may further include operation 638 depicting obtaining the one or more subtasks corresponding to the selected representation. For example, FIG. 2 shows one or more selected representations corresponding subtask obtaining module 238 obtaining (e.g., receiving or retrieving) the one or more subtasks (e.g., “determine the view from your location at Safeco field”) corresponding to the selected representation (e.g., the baseball icon).

Referring again to FIG. 6D, operation 634 may include operation 640 depicting receiving one or more symbols corresponding to one or more subtasks that correspond to at least one portion of at least one task requested by a task requestor. For example, FIG. 2 shows one or more symbols corresponding to one or more subtasks receiving module 240 receiving one or more symbols (e.g., the golden arches of McDonald's) (e.g., “determine the wireless network strength at McDonald's in Bellevue, Wash.) that correspond to at least one portion of at least one task (e.g., “determine which McDonald's of the ones in Bellevue, Wash., have the fastest interne connection”) requested by a task requestor.

Referring again to FIG. 6D, operation 640 may include operation 642 depicting receiving one or more selectable symbols corresponding to one or more subtasks that correspond to at least one portion of at least one task requested by a task requestor. For example, FIG. 2 shows one or more selectable symbols corresponding to one or more subtasks receiving module 242 receiving one or more selectable symbols (e.g., a selectable icon, e.g., a window of a fancy restaurant) corresponding to one or more subtasks (e.g., “determine the view from your table at La Blanca”) that correspond to at least one portion of at least one task of acquiring data (e.g., “determine which tables at La Blanca have a window view of the Space Needle”) requested by a task requestor.

Referring again to FIG. 6D, operation 642 may include operation 644 depicting receiving one or more selectable icons corresponding to one or more subtasks that correspond to at least one portion of at least one task requested by a task requestor. For example, FIG. 2 shows one or more selectable icons corresponding to one or more subtasks receiving module receiving one or more selectable icons (e.g., receiving the icons from an external source) corresponding to one or more subtasks (e.g., “respond to a query regarding how cloudy the sky is”) that correspond to at least one portion of at least one task (e.g., “predict the weather over the next six hours in Belltown neighborhood”) requested by a task requestor.

Referring now to FIG. 6E, operation 636 may include operation 646 depicting presenting the one or more representations, wherein the one or more representations are configured to be selected. For example, FIG. 2 shows selectably-configured representation presentation module 246 presenting (e.g., expressing to a user) the one or more representations (e.g., a sensory depiction), wherein the one or more representations are configured to be selected (e.g., the user can pick one or more of the representations).

Referring again to FIG. 6E, operation 636 may include operation 648 depicting receiving a selection of one of the one or more representations configured to be selected. For example, FIG. 2 shows selectably-configured representation selection receiving module 248 receiving a selection (e.g., receiving a user input to select one of the icons, e.g., with a finger on a touchscreen, or with a mouse or other pointing device, or, e.g., receiving a voice command indicating selection of a representation) of one of the one or more representations configured to be selected (e.g., a group of selectable icons).

Referring again to FIG. 6E, operation 646 may include operation 650 depicting displaying one or more symbols corresponding to one or more subtasks, wherein the one or more symbols are configured to be selected. For example, FIG. 2 shows selectably-configured symbol displaying module 250 displaying one or more symbols (e.g., 3D graphics) corresponding to one or more subtasks (e.g., “activate the air quality sensor”), wherein the one or more symbols are configured to be selected (e.g., the 3D graphics are configured to receive a user input to select one of the symbols, e.g., with a finger on a touchscreen, or with a mouse or other pointing device).

Referring again to FIG. 6E, operation 650 may include operation 652 depicting displaying one or more selectable icons corresponding to one or more subtasks on a display, wherein the one or more selectable icons are configured to be selected. For example, FIG. 2 shows selectable icon displaying module 252 displaying one or more selectable icons (e.g., selectable graphics above representative text) corresponding to one or more subtasks (e.g., “determine the exact time of sunset at your particular location”) on a display, wherein the one or more selectable icons are configured to be selected (e.g., configured to receive a user input to select one of the selectable icons , e.g., with a finger on a touchscreen, or with a mouse or other pointing device).

Referring now to FIG. 6F, operation 648 may include operation 654 depicting receiving a signal indicating an interaction between one of the one or more representations and an exterior stimulus. For example, FIG. 2 shows selectably-configured representation external stimulus interaction signal receiving module 254 receiving a signal indicating an interaction between one of the one or more representations (e.g., a heart icon) and an exterior stimulus (e.g., a finger or a stylus touching a screen where the heart icon is displayed to indicate selection of the heart icon).

Referring again to FIG. 6F, operation 648 may include operation 656 depicting receiving a signal indicating that one of the one or more representations was pre-selected. For example, FIG. 2 shows pre-selection indication signal receiving module 256 receiving a signal indicating that one (e.g., a clock icon) of the one or more representations (e.g., a clock icon, a heart icon, and a cloud icon) was pre-selected (e.g., the receiver of the representations had previously determined to select clock icons, e.g., in accordance with a user's wishes for subtasks the user wishes to carry out).

Referring now to FIG. 6G, operation 638 may include operation 658 depicting receiving the one or more subtasks corresponding to the selected representation. For example, FIG. 2 shows one or more selected representations corresponding subtask receiving module 258 receiving the one or more subtasks (e.g., “determine how many double chocolate donuts are remaining at the Krispy Kreme at your location”) corresponding to the selected representation (e.g., a 3D icon of a doughnut).

Referring again to FIG. 6G, operation 638 may include operation 660 depicting transmitting data corresponding to the selection of the representation. For example, FIG. 2 shows selected representation data transmitting module 260 transmitting data corresponding to the selection (e.g., transmitting a signal indicating which representation was selected) of the representation (e.g., the representation is an Eiffel Tower icon).

Referring again to FIG. 6G, operation 238 may further include operation 662 depicting receiving the one or more subtasks corresponding to the selected representation. For example, FIG. 2 shows subtask corresponding to selected representation receiving module 262 receiving the one or more subtasks (e.g., “take a picture of the Eiffel Tower”) corresponding to the selected representation (e.g., the Eiffel Tower icon).

Referring again to FIG. 6G, operation 660 may include operation 664 depicting transmitting data corresponding to the selection of the representation to a service provider. For example, FIG. 2 shows selected representation data to service provider transmitting module 264 transmitting data corresponding to the selection (e.g., transmitting a signal indicating which representation was selected) of the representation (e.g., a doughnut icon) to a service provider (e.g., Google, which may be facilitating the subtask transmission to the discrete interface device).

Referring again to FIG. 6G, operation 664 may include operation 666 depicting transmitting data corresponding to the selection of the representation to a subtask creator. For example, FIG. 2 shows selected representation data to subtask creator transmitting module 266 transmitting data corresponding to the selection (e.g., transmitting a signal indicating which representation was selected) of the representation (e.g., an audible voice saying “Eiffel Tower subtask”) to a subtask creator (e.g., an entity that created the subtask (e.g., “take a picture of the Eiffel Tower”) from a task of acquiring data (e.g., “obtain a 360-degree near real-time picture of the Eiffel Tower”).

Referring again to FIG. 6G, operation 664 may include operation 668 depicting transmitting data corresponding to the selection of the representation to a social network provider. For example, FIG. 2 shows selected representation data to social network provider transmitting module 268 transmitting data corresponding to the selection (e.g., transmitting a signal indicating which representation was selected) of the representation (e.g., a smiling face icon) to a social network provider (e.g., Facebook).

Referring again to FIG. 6G, operation 262 may include operation 670 depicting receiving the one or more subtasks corresponding to the selected representation from a service provider. For example, FIG. 2 shows subtask corresponding to selected representation service provider receiving module 270 receiving the one or more subtasks (e.g., “take a picture of the people in line in the coffee shop at your location”) corresponding to the selected representation (e.g., a smiling face icon) from a service provider (e.g., Facebook).

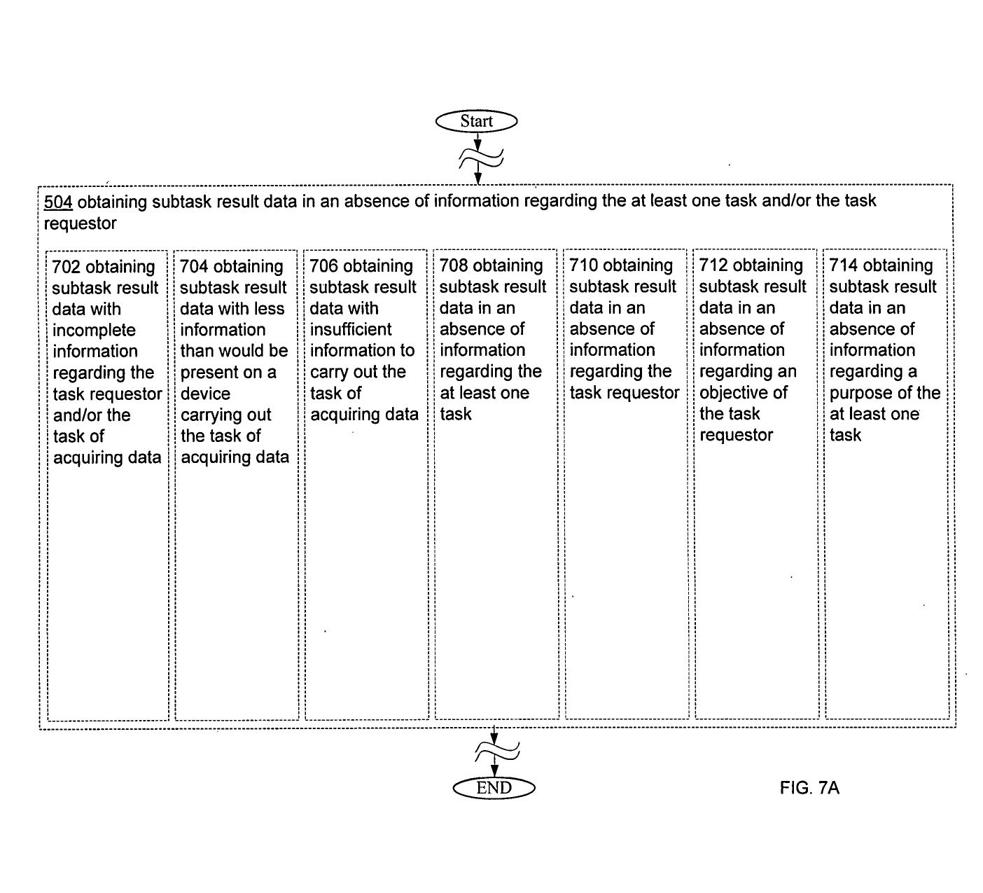

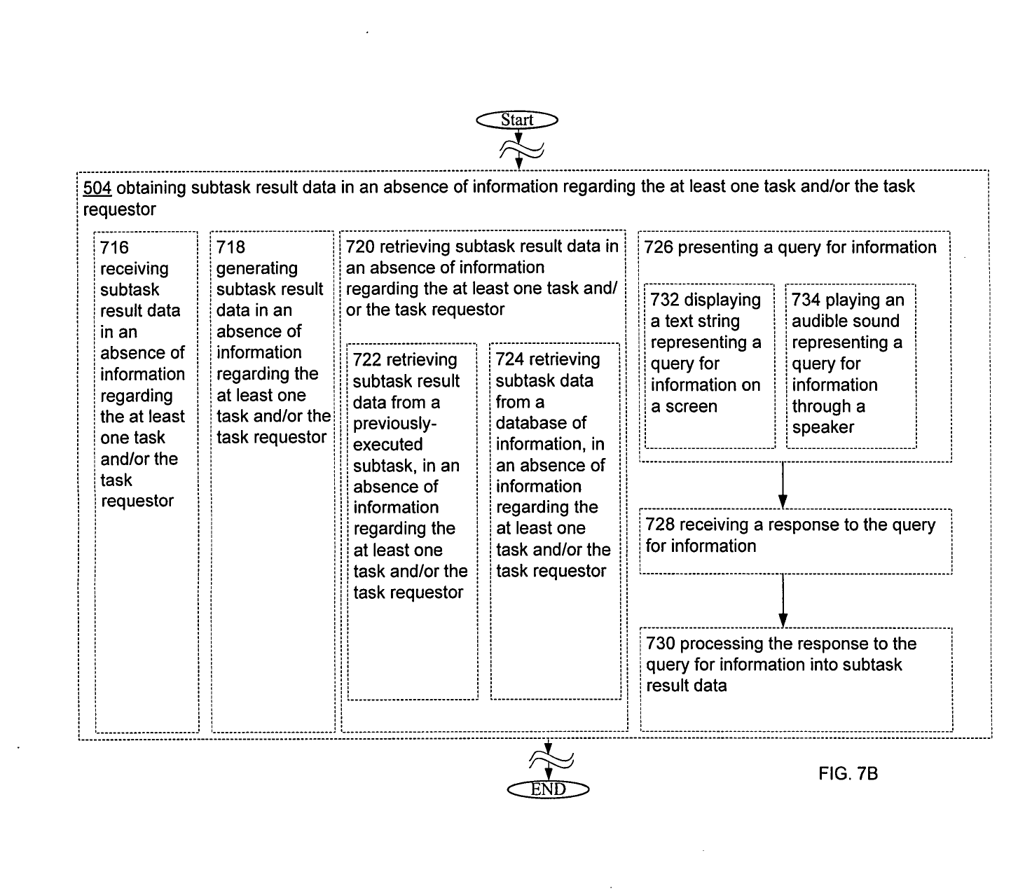

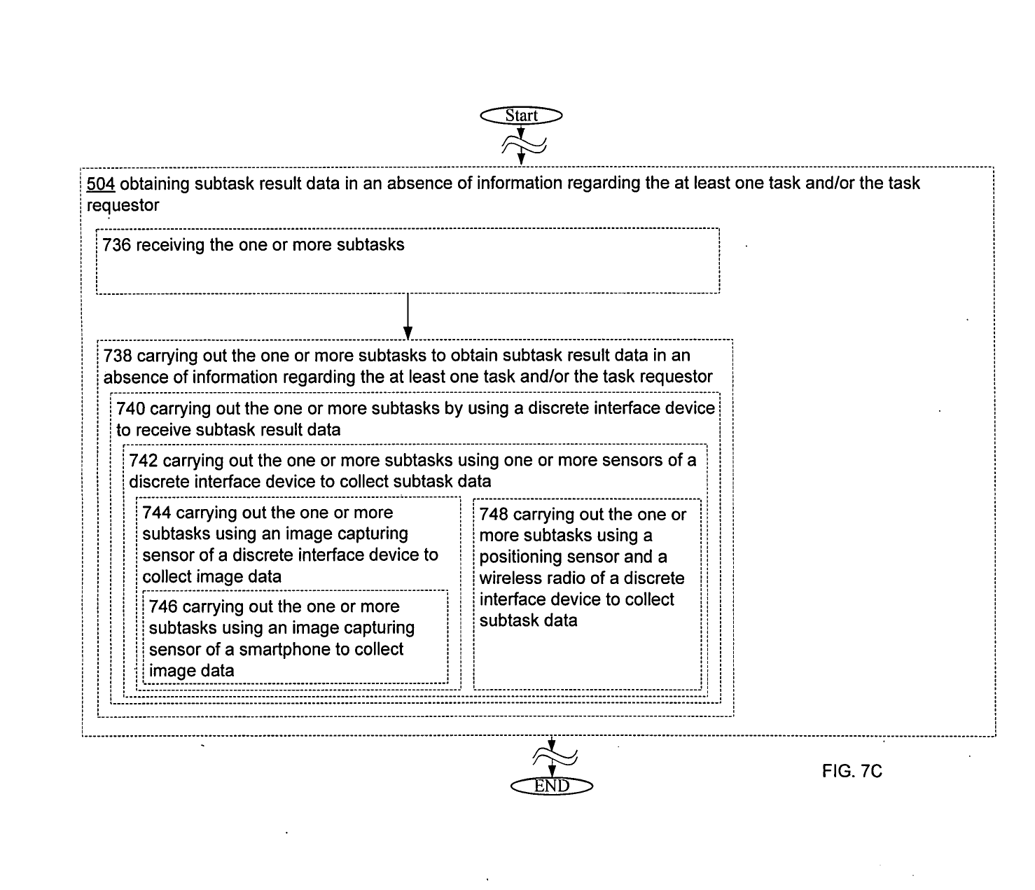

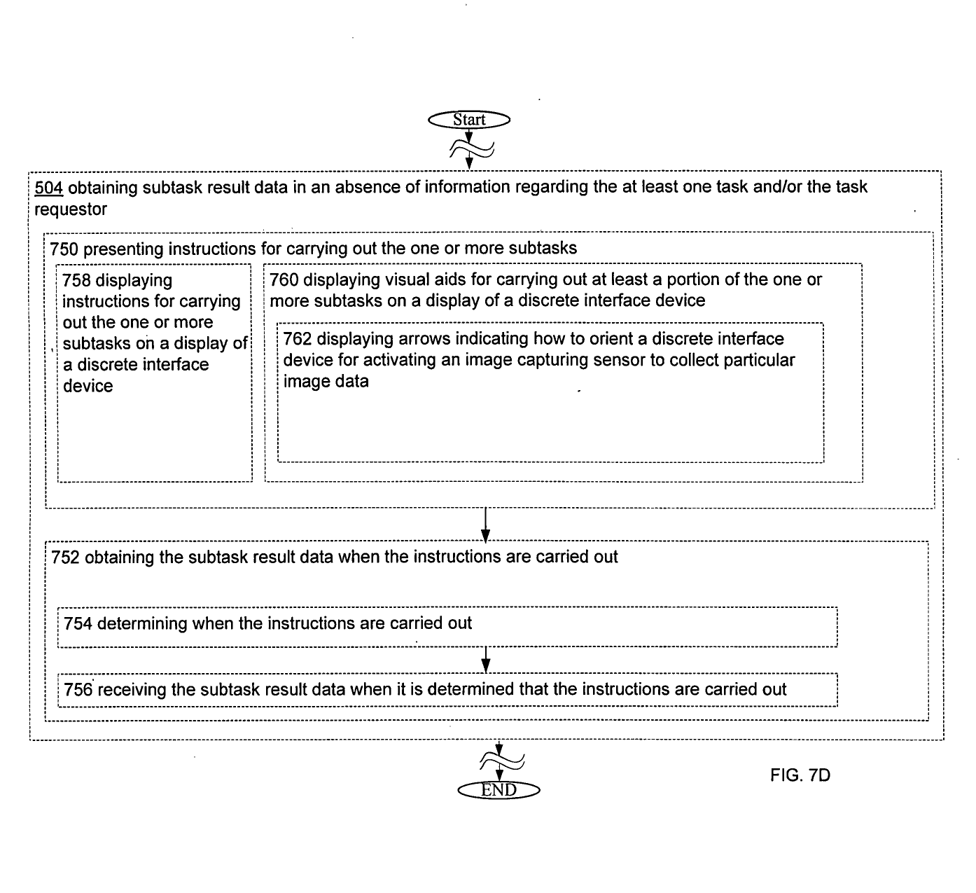

FIGS. 7A-7D depict various implementations of operation 504, according to embodiments. Referring now to FIG. 7A, operation 504 may include operation 702 depicting obtaining subtask result data with incomplete information regarding the task requestor and/or the task of acquiring data. For example, FIG. 3 shows incomplete information subtask result data obtaining module 302 obtaining (e.g., carrying out the subtask or retrieving the data from a previously-executed subtask) subtask result data (e.g., velocity information from a subtask of “determine how fast you are moving across the I-90 bridge at your location”) with incomplete information (e.g., the Apple iPhone and the BlackBerry 8800 do not know the identity of the task requestor or the type of entity, e.g., personal, corporate, automated) and/or the task of acquiring data (e.g., for the task of “determine the fastest way into Seattle at 4:25 PM from Bellevue, Wash.,” the subtask result data is obtained without knowing the task, and whether the task is “determine the fastest way,” or “monitor traffic conditions,” or any details about how the information the devices are gathering will be used, and to answer which queries).

Referring again to FIG. 7A, operation 504 may include operation 704 depicting obtaining subtask result data with less information than would be present on a device carrying out the task of acquiring data. For example, FIG. 3 shows less information subtask result data obtaining module 304 obtaining (e.g., carrying out the subtask or retrieving the data from a previously-executed subtask) subtask result data (e.g., image data from the subtask of “determine the view from your location at Safeco field”) with less information than would be present on a device carrying out the task of acquiring data (e.g., when the subtask is carried out, only the image collecting component is activated and data is collected. The task is “determine how full the rows are in the upper deck at Safeco Field.” The device or devices carrying out the subtask have no idea whether they are capturing images of the fans in the stands, of the view, of the weather, of the sunlight, or of the best time to avoid shadows, or to determine whether the seats are covered. In contrast, a device carrying out the task by itself (which would have to go to each row of the park) would know to determine how full the rows are because of knowledge of the task).

Referring again to FIG. 7A, operation 504 may include operation 706 depicting obtaining subtask result data with insufficient information to carry out the task of acquiring data. For example, FIG. 3 shows insufficient information subtask result data obtaining module 306 obtaining (e.g., carrying out the subtask or retrieving the data from a previously-executed subtask) subtask result data (e.g., “determine the wireless network strength at McDonald's in Bellevue, Wash.) with insufficient information to carry out the task of acquiring data (e.g., the task of acquiring data is “determine which McDonald's of the ones in Bellevue, Wash., have the fastest internet connection.” The interface devices have insufficient information to complete this task because they are merely measuring wireless strength at McDonald's. They do not know whether to measure strength at various McDonald's, various types of signal strength at that McDonald's (e.g., cellular network strength), whether to measure the signal strength at a particular time, or over a particular period of time. The interface devices have insufficient information to carry out the entire task, but are capable of carrying out the received subtask in order to obtain the subtask result data).

Referring again to FIG. 7A, operation 504 may include operation 708 depicting obtaining subtask result data in an absence of information regarding the at least one task. For example, FIG. 3 shows absent task information subtask result data obtaining module 308 obtaining (e.g., carrying out the subtask or retrieving the data from a previously-executed subtask) subtask result data (e.g., “take a picture of Times Square”) in an absence of information regarding the at least one task (e.g., the task is “take a 360-degree picture of Times Square when the new Reebok ad pops up at 8:01:32 a.m.,” and the discrete interface devices do not have the information that this is the task).

Referring again to FIG. 7A, operation 504 may include operation 710 depicting obtaining subtask result data in an absence of information regarding the task requestor. For example, FIG. 3 shows absent task requestor information subtask result data obtaining module 310 obtaining (e.g., carrying out the subtask or retrieving the data from a previously-executed subtask) subtask result data (e.g., “take a picture of Times Square”) in an absence of information regarding the task requestor (e.g., the task is “take a 360-degree picture of Times Square when the new Reebok ad pops up at 8:01:32 a.m.,” and the task requestor is Reebok, and the discrete interface devices do not have the information regarding the task requestor, e.g., identity, or which type, e.g., corporate or personal, human or machine query).

Referring again to FIG. 7A, operation 504 may include operation 712 depicting obtaining subtask result data in an absence of information regarding an objective of the task requestor. For example, FIG. 3 shows absent task requestor objective information subtask result data obtaining module 312 obtaining (e.g., carrying out the subtask or retrieving the data from a previously-executed subtask) subtask result data (e.g., “determine the loudness level at your seat during the Pearl Jam concert”) in an absence of information regarding an objective of the task requestor (e.g., discrete interface device does not know who made the request, the identity of the task requestor, or even whether the task requestor is a corporate entity interested in tracking Pearl Jam's popularity, an old lady trying to decide if the concert will be too loud for her, a young couple determining whether to bring their infant to the show, or a Pearl Jam fan site webmaster tracking information about Pearl Jam at shows that he cannot attend personally).

Referring again to FIG. 7A, operation 504 may include operation 714 depicting obtaining subtask result data in an absence of information regarding a purpose of the at least one task. For example, FIG. 3 shows absent task purpose information subtask result data obtaining module 314 obtaining (e.g., carrying out the subtask or retrieving the data from a previously-executed subtask) subtask result data (e.g., “how much rain fell in your location in the last six hours”) in an absence of information regarding a purpose of the at least one task (e.g., the task is “track rainfall data in Seattle by neighborhood on January 21, and is configured to be carried out without knowing if the purpose is to “track rainfall” or “determine where to visit in order to get sunshine,” or “predict the weather patterns moving east”).

Referring now to FIG. 7B, operation 504 may include operation 716 depicting receiving subtask result data in an absence of information regarding the at least one task and/or the task requestor. For example, FIG. 3 shows absent information subtask result data receiving module 316 receiving (e.g., receiving from a sensor of a device, or receiving from a database of previously-stored subtask results) subtask result data (e.g., an upload speed measurement from a subtask of “measure cellular network upload speed at your location”) result data in an absence of (e.g., less, incomplete, missing, or withheld) information regarding the at least one task and/or the task requestor.

Referring again to FIG. 7B, operation 504 may include operation 718 depicting generating subtask result data in an absence of information regarding the at least one task and/or the task requestor. For example, FIG. 3 shows absent information subtask result data receiving module 318 generating (e.g., creating, e.g., acquiring data from a sensor and performing data manipulation, e.g., error correction, e.g., color correction on image data, or other similar analysis) subtask result data (e.g. image data from a subtask of “take a picture of the view you're your location at the Kennedy Center”) in an absence of (e.g., less, incomplete, missing, or withheld) information regarding the at least one task and/or the task requestor.

Referring again to FIG. 7B, operation 504 may include operation 720 depicting retrieving subtask result data in an absence of information regarding the at least one task and/or the task requestor. For example, FIG. 3 shows absent information subtask result data retrieving module 320 retrieving subtask result data (e.g., image data from a subtask of “take a picture of the Eiffel Tower,” and the image data is from a picture taken last week), in an absence of information regarding the at least one task and/or the task requestor (e.g., either at the time of carrying out the subtask, or at the time the subtask result data is retrieved.

Referring again to FIG. 7B, operation 720 may include operation 722 depicting retrieving subtask result data from a previously-executed subtask, in an absence of information regarding the at least one task and/or the task requestor. For example, FIG. 3 shows absent information subtask result from previously-executed subtask data retrieving module 322 retrieving subtask result data (e.g., image data from a subtask of “take a picture of the Eiffel Tower,”) from a previously-executed subtask (e.g., the image data is from a picture of the Eiffel Tower taken last week), in an absence of information regarding the at least one task and/or the task requestor (e.g., either at the time of carrying out the subtask, or at the time the subtask result data is retrieved.

Referring again to FIG. 7B, operation 720 may include operation 724 depicting retrieving subtask data from a database of information, in an absence of information regarding the at least one task and/or the task requestor. For example, FIG. 3 shows absent information subtask information database subtask data retrieving module 324 retrieving subtask data (e.g., image data from a subtask of “take a picture of Times Square”) from a database of information (e.g., a picture database including pictures of times square), in an absence of information regarding the at least one task and/or the task requestor (e.g., either at the time of carrying out the subtask, or at the time the subtask result data is retrieved.

Referring again to FIG. 7B, operation 504 may include operation 726 depicting presenting a query for information. For example, FIG. 3 shows information query presenting module 326 presenting (e.g., expressing to a user) a query for information (e.g., “please enter a number from 1 to 10 indicating the freshness of the baked goods at the coffee shop at your location”).

Referring again to FIG. 7B, operation 504 may further include operation 728 depicting receiving a response to the query for information. For example, FIG. 3 shows information query response receiving module 328 receiving a response (e.g., a keyed-in “5”) to the query for information (e.g., “please enter a number from 1 to 10 indicating the freshness of the baked goods at the coffee shop at your location”).

Referring again to FIG. 7B, operation 504 may further include operation 730 depicting processing the response to the query for information into subtask result data. For example, FIG. 3 shows received information query response data processing module 330 processing the response to the query for information (e.g., “please enter a number from 1 to 10 indicating the freshness of the baked goods at the coffee shop at your location”) into subtask result data (e.g., processing the keyed-in “5” into a signal indicating that the freshness is around 50% based on the response to the query).

Referring again to FIG. 7B, operation 726 may include operation 732 depicting displaying a text string representing a query for information on a screen. For example, FIG. 3 shows information query as text string screen displaying module 332 displaying a text string (e.g., “please enter how many people are in front of you in line”) representing a query for information (e.g., how many people are in front of the user of the discrete interface device in line”) on a screen (e.g., a display of the discrete interface device).

Referring again to FIG. 7B, operation 726 may include operation 734 depicting playing an audible sound representing a query for information through a speaker. For example, FIG. 3 shows information query as audible sound speaker playing module 334 playing an audible sound (e.g., a voice of “please enter a number from 1 to 10 indicating the freshness of the baked goods at the coffee shop at your location”) representing a query for information through a speaker.

Referring now to FIG. 7C, operation 504 may include operation 736 depicting receiving the one or more subtasks. For example, FIG. 3 shows subtask receiving module 336 receiving the one or more subtasks (e.g., “determine whether the barometric pressure is dropping at your location”).

Referring again to FIG. 7C, operation 504 may further include operation 738 depicting carrying out the one or more subtasks to obtain subtask result data in an absence of information regarding the at least one task and/or the task requestor. For example, FIG. 3 shows subtask result data obtaining by absent information subtask carrying out module 338 carrying out (e.g., taking the necessary steps to complete the subtask, e.g., orienting the device, activating the sensor) the one or more subtasks (e.g., “determine whether your seat at Verizon Center for the Washington Capitals has a view of the opposing goalie”) to obtain subtask result data (e.g., image data) in an absence of information regarding the at least one task and/or the task requestor.

Referring again to FIG. 7C, operation 738 may include operation 740 depicting carrying out the one or more subtasks by using a discrete interface device to receive subtask result data. For example, FIG. 3 shows subtask result data obtaining by discrete interface device subtask carrying out module 340 carrying out (e.g., taking the necessary steps to complete the subtask, e.g., orienting the device, activating the sensor) the one or more subtasks (e.g., “activate the image capturing sensor and determine how many people appear in the captured image”) using a discrete interface device to receive subtask result data (e.g., a component of the discrete interface device is used to collect the data for the subtask result data).

Referring again to FIG. 7C, operation 740 may include operation 742 depicting carrying out the one or more subtasks using one or more sensors of a discrete interface device to collect subtask data. For example, FIG. 3 shows subtask result data obtaining using discrete interface device sensor carrying out module 342 carrying out the one or more subtasks (e.g., “take a picture of the Eiffel Tower”) using one or more sensors of a discrete interface device (e.g., an image capturing sensor).

Referring again to FIG. 7C, operation 742 may include operation 744 depicting carrying out the one or more subtasks using an image capturing sensor of a discrete interface device to collect image data. For example, FIG. 3 shows subtask result data obtaining using discrete interface device image capturing sensor carrying out module 344 carrying out the one or more subtasks (e.g., “take a picture of the Eiffel Tower”) using an image capturing sensor of a discrete interface device (e.g., an image capturing sensor).

Referring again to FIG. 7C, operation 744 may include operation 746 depicting carrying out the one or more subtasks using an image capturing sensor of a smartphone to collect image data. For example, FIG. 3 shows subtask result data obtaining using smartphone image capturing sensor carrying out module 346 carrying out the one or more subtasks (e.g., “take a picture of the Eiffel Tower”) using an image capturing sensor of a smartphone (e.g., an Apple iPhone).

Referring again to FIG. 7C, operation 742 may include operation 748 depicting carrying out the one or more subtasks using a positioning sensor and a wireless radio of a discrete interface device to collect subtask data. For example, FIG. 3 shows subtask result data obtaining using discrete interface device radio and positioning sensor carrying out module 348 carrying out the one or more subtasks (e.g., “determine a number of WPA encrypted wireless networks visible at your present location”) using a positioning sensor and a wireless radio of a discrete interface device to collect subtask data.

Referring now to FIG. 7D, operation 504 may include operation 750 depicting presenting instructions for carrying out the one or more subtasks. For example, FIG. 3 shows carrying out subtask instruction presenting module 352 presenting instructions (e.g., expressing instructions to a user) for carrying out the one or more subtasks (e.g., “determine the exact time of sunset at your particular location”).

Referring again to FIG. 7D, operation 504 may further include operation 752 depicting obtaining the subtask result data when the instructions are carried out. For example, FIG. 3 shows carried out instruction subtask result data obtaining module 352 obtaining the subtask result data (e.g., time data) when the instructions are carried out (e.g., telling the user what to look for, when to activate the image capturing sensor, analyzing the data received from the image capturing sensor).

Referring again to FIG. 7D, operation 752 may include operation 754 depicting determining when the instructions are carried out. For example, FIG. 3 shows determining when instructions are carried out determining module 354 determining when the instructions are carried out (e.g., detecting when the user is carrying out the instructions that were presented to the user).

Referring again to FIG. 7D, operation 752 may further include operation 756 depicting receiving the subtask result data when it is determined that the instructions are carried out. For example, FIG. 3 shows receiving subtask result data upon determination of carried out instruction receiving module 356 receiving the subtask result data when it is determined that the instructions are carried out (e.g., when the interface device determines that the instructions are carried out (e.g., point the image capturing sensor in the indicated direction), the subtask result data (e.g., image data for a subtask of capturing an image of the Eiffel Tower) is received).

Referring again to FIG. 7D, operation 750 may include operation 758 depicting displaying instructions for carrying out the one or more subtasks on a display of a discrete interface device. For example, FIG. 3 shows carrying out subtask instruction displaying module 358 displaying instructions for carrying out the one or more subtasks (e.g., “determine how many double chocolate donuts are remaining at the Krispy Kreme at your location, and enter the number on the keypad”).

Referring again to FIG. 7D, operation 750 may include operation 760 depicting displaying visual aids for carrying out at least a portion of the one or more subtasks on a display of a discrete interface device. For example, FIG. 3 shows carrying out subtask visual aid discrete interface device displaying module 360 displaying visual aids (e.g., 3D arrows pointing in the direction in which the image capturing device should be pointed) for carrying out at least a portion of the one or more subtasks (e.g., “acquire an image of the Eiffel Tower”) on a display of a discrete interface device (e.g., a smartphone with a screen on one side and an image capturing sensor on the other, e.g., a BlackBerry 8800).

Referring again to FIG. 7D, operation 760 may include operation 762 depicting displaying arrows indicating how to orient a discrete interface device for activating an image capturing sensor to collect particular image data. For example, FIG. 3 shows displaying arrows indicating how to orient a discrete interface device (e.g., a discrete interface device is north of the Washington Monument, and the arrows would thus indicate to orient the discrete interface devices with the image capturing sensor pointing to the south) for activating an image capturing sensor to collect particular image data (e.g., an image of the Washington Monument).

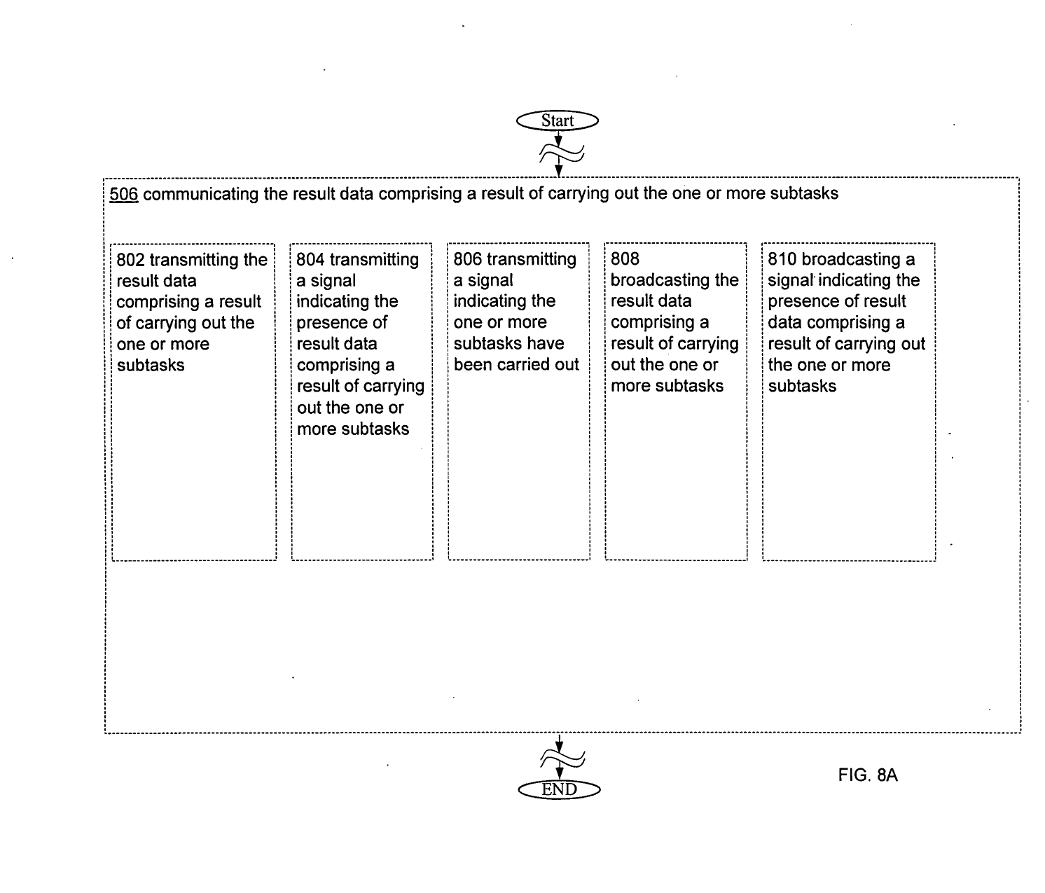

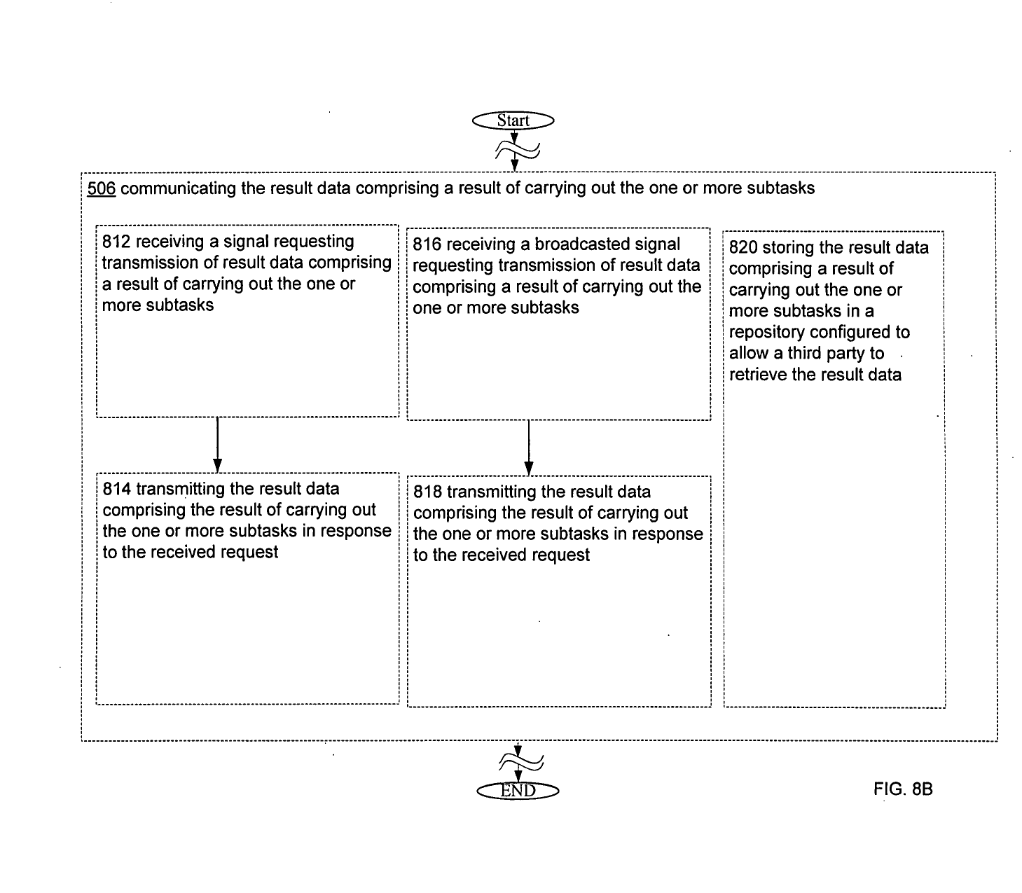

FIGS. 8A-8B depict various implementations of operation 506, according to embodiments. Referring now to FIG. 8A, operation 506 may include operation 802 depicting transmitting the result data comprising a result of carrying out the one or more subtasks. For example, FIG. 4 shows result data of result of executed one or more subtasks transmitting module 402 transmitting the result data (e.g., the image data) comprising a result of carrying out the one or more subtasks (e.g., the image data that is a result of activating an image capturing sensor to carry out a subtask of “take a picture of the Space Needle”).

Referring again to FIG. 8A, operation 506 may include operation 804 depicting transmitting a signal indicating the presence of result data comprising a result of carrying out the one or more subtasks. For example, FIG. 4 shows signal indicating presence of subtask result data transmitting module 404 transmitting a signal (e.g., a message stating “I have carried out a subtask and am in possession of subtask result data”) indicating the presence of result data comprising a result of carrying out the one or more subtasks (e.g., “determine the loudness at the Pearl Jam concert from particular spots at Key Arena”).

Referring again to FIG. 8A, operation 506 may include operation 806 depicting transmitting a signal indicating the one or more subtasks have been carried out. For example, FIG. 4 shows signal indicating one or more executed subtasks transmitting module 406 transmitting a signal (e.g., sending, broadcasting, or displaying) a signal (e.g., to a receiver of subtask result data) indicating the one or more subtasks (e.g., “determine the view of the third trumpeter at the London Philharmonic from various seats at the Kennedy Center”) have been carried out (e.g., the signal does not contain the subtask result data but rather an indicator that the subtask has been carried out.

Referring again to FIG. 8A, operation 506 may include operation 808 depicting broadcasting the result data comprising a result of carrying out the one or more subtasks. For example, FIG. 4 shows result data of result of executed one or more subtasks broadcasting module 408 broadcasting (e.g., sending the result data to a nonspecific destination, such that the result data may be received by more than one entity) comprising a result (e.g., image data) of carrying out the one or more subtasks (e.g., “capture the image data at Times Square at 8:05 am”.)

Referring again to FIG. 8A, operation 506 may include operation 810 depicting broadcasting a signal indicating the presence of result data comprising a result of carrying out the one or more subtasks. For example, FIG. 4 shows signal indicating presence of subtask result data broadcasting module 410 (e.g., sending the result data to a nonspecific destination, such that the result data may be received by more than one entity) indicating the presence of result data (e.g., a signal indicating that the interface device has subtask result data, but the subtask result data is not in the signal, instead it is an invitation to retrieve the data) comprising a result of carrying out the one or more subtasks (e.g., “take a picture of the Space Needle”).

Referring now to FIG. 8B, operation 506 may include operation 812 depicting receiving a signal requesting transmission of result data comprising a result of carrying out the one or more subtasks. For example, FIG. 4 shows receiving transmitted signal request for subtask result data 412 receiving a signal requesting transmission of result data (e.g., a request for result data received by a discrete interface device) comprising a result (e.g., a number) of carrying out the one or more subtasks (e.g., “determine how many people are sitting in your row at Safeco Field”).

Referring again to FIG. 8B, operation 506 may further include operation 814 depicting transmitting the result data comprising the result of carrying out the one or more subtasks in response to the received request. For example, FIG. 4 shows subtask result data responsive transmitting module 414 transmitting the result data (e.g., a number, or, in some examples, image data showing your row) comprising the result of carrying out the one or more subtasks (e.g., “determine how many people are sitting in your row at Safeco Field”) in response to the received request (e.g., the result data is transmitted only after the request for result data is received).

Referring again to FIG. 8B, operation 506 may include operation 816 depicting receiving a broadcasted signal requesting transmission of result data comprising a result of carrying out the one or more subtasks. For example, FIG. 4 shows receiving broadcasted signal request for subtask result data 416 receiving a broadcasted signal (e.g., a nonspecific or non interface-device targeted, or a multiple target intended signal) requesting transmission of result data (e.g., speed data comprising a result of carrying out the one or more subtasks (e.g., “determine the traffic through Mercer St. in Seattle at the current time”).

Referring again to FIG. 8B, operation 506 may further include operation 818 depicting transmitting the result data comprising the result of carrying out the one or more subtasks in response to the received request. For example, FIG. 4 shows subtask result data broadcast responsive transmitting module 418 transmitting the result data (e.g., the speed data) comprising the result of carrying out the one or more subtasks (e.g., “determine the traffic through Mercer St. in Seattle at the current time”) in response to the received request (e.g., the result data is transmitted only after the broadcasted request for result data is received).

Referring again to FIG. 8B, operation 506 may include operation 820 depicting storing the result data comprising a result of carrying out the one or more subtasks in a repository configured to allow a third party to retrieve the result data. For example, FIG. 4 shows result data of result of executed one or more subtasks third-party retrievable repository storing module 420 storing the result data (e.g., storing in memory, or transmitting to a remote storage operated under the control of a third party) comprising a result (e.g., image data) of carrying out the one or more subtasks (e.g., “take a picture of the Space Needle”) in a repository (e.g., a storage, e.g., a memory, or a database, or a hard drive, or a space on a server) configured to allow a third party (e.g., a party that will ultimately receive the subtask result data and use the result data or transmit the result data to an entity that will use the subtask result data to acquire a result of the task of acquiring data) configured to allow a third party (e.g. a party with predetermined access to the result data) to retrieve the result data (e.g., image data).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.) , (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. In addition, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-137. (canceled)

138. A system, comprising:
a one or more two-or-more discrete interface device configured subtasks corresponding to at least one portion of a task requested by a subtask requestor representation receiving module configured to receive one or more representations of one or more subtasks that correspond to at least one portion of at least one task of acquiring data requested by a task requestor, wherein the one or more subtasks are configured to be carried out by at least two discrete interface devices;
an absent information subtask result data obtaining module configured to obtain subtask result data in an absence of information regarding the at least one task and/or the task requestor; and
a result data of result of executed one or more subtasks communicating module configured to communicating the result data comprising a result of carrying out the one or more subtasks.

139. The system of claim 138, wherein said one or more two-or-more discrete interface device configured subtasks corresponding to at least one portion of a task requested by a subtask requestor representation receiving module comprises:
a one or more indicated discrete interface device configured subtasks corresponding to at least one portion of a task requested by a subtask requestor representation receiving module configured to receive one or more representations indicating one or more subtasks that correspond to at least one portion of at least one task requested by a task requestor, wherein the one or more subtasks are configured to be carried out by at least two discrete interface devices.

140. (canceled)

141. The system of claim 139, wherein said one or more indicated discrete interface device configured subtasks corresponding to at least one portion of a task requested by a subtask requestor representation receiving module comprises:
a one or more representations indicating subtask receiving availability receiving module configured to receive a representation indicating that one or more subtasks are available for receiving.

142. The system of claim 141, wherein said one or more two-or-more discrete interface device configured subtasks corresponding to at least one portion of a task requested by a subtask requestor representation receiving module further comprises:
a subtasks indicated as available receiving module configured to receive the one or more subtasks for which an indication of availability was received.

143. The system of claim 138, wherein said one or more two-or-more discrete interface device configured subtasks corresponding to at least one portion of a task requested by a subtask requestor representation receiving module comprises:
a two-or-more discrete interface device configured subtask receiving module configured to receive one or more subtasks that correspond to at least one portion of at least one task requested by a task requestor, wherein the one or more subtasks are configured to be carried out by at least two discrete interface devices.

144. The system of claim 143, wherein said two-or-more discrete interface device configured subtask receiving module comprises:
a two-or-more discrete interface device configured one subtask receiving module configured to receive one subtask corresponding to at least one portion of at least one task requested by a task requestor, wherein the one or more subtasks are configured to be carried out by at least two discrete interface devices.

145. The system of claim 143, wherein said two-or-more discrete interface device configured subtask receiving module comprises:
a representation corresponding to received subtask presenting module configured to present a representation corresponding to the received one subtask corresponding to at least one portion of at least one task requested by a task requestor.

146. (canceled)

147. (canceled)

148. The system of claim 138, wherein said one or more two-or-more discrete interface device configured subtasks corresponding to at least one portion of a task requested by a subtask requestor representation receiving module comprises:
a two-or-more discrete interface device configured subtasks corresponding to at least one portion of a task requested by a subtask requestor group of subtasks representation receiving module configured to receive a group of subtasks, each subtask corresponding to at least one portion of at least one task requested by a task requestor, wherein the one or more subtasks are configured to be carried out by at least two discrete interface devices.

149. The system of claim 148, wherein said two-or-more discrete interface device configured subtasks corresponding to at least one portion of a task requested by a subtask requestor group of subtasks representation receiving module comprises:
a two-or-more discrete interface device configured subtasks corresponding to at least one portion of a task requested by a subtask requestor group of subtasks having a particular attribute representation receiving module configured to receive a group of subtasks, each having a particular subtask attribute, each subtask corresponding to at least one portion of at least one task requested by a task requestor, wherein the one or more subtasks are configured to be carried out by at least two discrete interface devices.

150. The system of claim 149, wherein said two-or-more discrete interface device configured subtasks corresponding to at least one portion of a task requested by a subtask requestor group of subtasks having a particular attribute representation receiving module comprises:
a two-or-more discrete interface device configured subtasks corresponding to at least one portion of a task requested by a subtask requestor group of subtasks having a completion prerequisite representation receiving module configured to receive a group of subtasks, each having a prerequisite for completion, each subtask corresponding to at least one portion of at least one task requested by a task requestor, wherein the one or more subtasks are configured to be carried out by at least two discrete interface devices.

151. The system of claim 150, wherein said two-or-more discrete interface device configured subtasks corresponding to at least one portion of a task requested by a subtask requestor group of subtasks having a completion prerequisite representation receiving module comprises:
a two-or-more discrete interface device configured group of subtasks configured for execution on discrete interface devices having a particular status and/or characteristic representation receiving module configured to receive a group of subtasks, each configured to be executed on a discrete interface device having a particular status and/or characteristic, and each subtask corresponds to at least one portion of at least one task requested by a task requestor, wherein the one or more subtasks are configured to be carried out by at least two discrete interface devices.

152. The system of claim 151, wherein said two-or-more discrete interface device configured group of subtasks configured for execution on discrete interface devices having a particular status and/or characteristic representation receiving module comprises:
a two-or-more discrete interface device configured group of subtasks configured for execution on discrete interface devices having a particular status representation receiving module configured to receive a group of subtasks, each configured to be executed on a discrete interface device having a particular status, and each subtask corresponding to at least one portion of at least one task requested by a task requestor, wherein the one or more subtasks are configured to be carried out by at least two discrete interface devices.

153. The system of claim 151, wherein said two-or-more discrete interface device configured group of subtasks configured for execution on discrete interface devices having a particular status and/or characteristic representation receiving module comprises:
a two-or-more discrete interface device configured group of subtasks configured for execution on discrete interface devices having a particular characteristic representation receiving module configured to receive a group of subtasks, each configured to be executed on a discrete interface device having a particular characteristic, and each subtask corresponding to at least one portion of at least one task requested by a task requestor, wherein the one or more subtasks are configured to be carried out by at least two discrete interface devices.

154. The system of claim 138, wherein said one or more two-or-more discrete interface device configured subtasks corresponding to at least one portion of a task requested by a subtask requestor representation receiving module comprises:
a one or more two-or-more discrete interface device configured subtasks corresponding to at least one portion of a task requested by a subtask requestor symbol receiving module configured to receive one or more symbols representing one or more subtasks that correspond to at least one portion of at least one task requested by a task requestor, wherein the one or more subtasks are configured to be carried out by at least two discrete interface devices.

155-169. (canceled)

170. The system of claim 138, wherein said absent information subtask result data obtaining module comprises:
an incomplete information subtask result data obtaining module configured to obtain subtask result data with incomplete information regarding the task requestor and/or the task of acquiring data.

171. The system of claim 138, wherein said absent information subtask result data obtaining module comprises:
a less information subtask result data obtaining module configured to obtain subtask result data with less information than would be present on a device carrying out the task of acquiring data.

172. The system of claim 138, wherein said absent information subtask result data obtaining module comprises:
an insufficient information subtask result data obtaining module configured to obtain subtask result data with insufficient information to carry out the task of acquiring data.

173. The system of claim 138, wherein said absent information subtask result data obtaining module comprises:
an absent task information subtask result data obtaining module configured to obtain subtask result data in an absence of information regarding the at least one task.

174. The system of claim 138, wherein said absent information subtask result data obtaining module comprises:
an absent task requestor information subtask result data obtaining module configured to obtain subtask result data in an absence of information regarding the task requestor.

175. (canceled)

176. The system of claim 138, wherein said absent information subtask result data obtaining module comprises:
an absent task purpose information subtask result data obtaining module configured to subtask result data in an absence of information regarding a purpose of the at least one task.

177. The system of claim 138, wherein said absent information subtask result data obtaining module comprises:
an absent information subtask result data receiving module configured to subtask result data in an absence of information regarding the at least one task and/or the task requestor.

178. The system of claim 138, wherein said absent information subtask result data obtaining module comprises:
an absent information subtask result data generating module configured to generate subtask result data in an absence of information regarding the at least one task and/or the task requestor.

179. The system of claim 138, wherein said absent information subtask result data obtaining module comprises:
an absent information subtask result data retrieving module configured to retrieve subtask result data in an absence of information regarding the at least one task and/or the task requestor.

180. The system of claim 179, wherein said absent information subtask result data retrieving module comprises:
an absent information subtask result from previously-executed subtask data retrieving module configured to retrieve subtask result data from a previously-executed subtask, in an absence of information regarding the at least one task and/or the task requestor.

181. The system of claim 179, wherein said absent information subtask result data retrieving module comprises:
an absent information subtask information database subtask data retrieving module configured to subtask data from a database of information, in an absence of information regarding the at least one task and/or the task requestor.

182. The system of claim 138, wherein said absent information subtask result data obtaining module comprises:
an information query presenting module;
an information query response receiving module; and
a received information query response data processing module configured to process the response to the query for information into subtask data.

183. (canceled)

184. The system of claim 182, wherein said information query presenting module comprises:
an information query as audible sound speaker playing module configured to play an audible sound representing a query for information through a speaker.

185. The system of claim 138, wherein said absent information subtask result data obtaining module comprises:
a subtask receiving module; and
a subtask result data obtaining by absent information subtask carrying out module configured to carry out the one or more subtasks to obtain subtask result data in an absence of information regarding the at least one task and/or the task requestor.

186. The system of claim 185, wherein said subtask result data obtaining by absent information subtask carrying out module comprises:
a subtask result data obtaining by discrete interface device subtask carrying out module configured to carry out the one or more subtasks by using a discrete interface device to receive subtask result data.

187. The system of claim 186, wherein said subtask result data obtaining by discrete interface device subtask carrying out module comprises:
a subtask result data obtaining using discrete interface device sensor carrying out module configured to carry out the one or more subtasks using one or more sensors of a discrete interface device to collect subtask data.

188. The system of claim 187, wherein said subtask result data obtaining using discrete interface device sensor carrying out module comprises:
a subtask result data obtaining using discrete interface device image capturing sensor carrying out module configured to carry out the one or more subtasks using an image capturing sensor of a discrete interface device to collect image data.

189. (canceled)

190. The system of claim 187, wherein said subtask result data obtaining using discrete interface device sensor carrying out module comprises:
a subtask result data obtaining using discrete interface device radio and positioning sensor carrying out module configured to carry out the one or more subtasks using a positioning sensor and a wireless radio of a discrete interface device to collect subtask data.

191. The system of claim 138, wherein said absent information subtask result data obtaining module comprises:
a carrying out subtask instruction presenting module; and
a carried out instruction subtask result data obtaining module.

192. The system of claim 191, wherein said carried out instruction subtask result data obtaining module comprises:
a determining when instructions are carried out determining module; and
a receiving subtask result data upon determination of carried out instruction receiving module.

193. The system of claim 191, wherein said carrying out subtask instruction presenting module comprises:
a carrying out subtask instruction displaying module.

194. (canceled)

195. (canceled)

196. The system of claim 138, wherein said result data of result of executed one or more subtasks communicating module comprises:
a result data of result of executed one or more subtasks transmitting module.

197. The system of claim 138, wherein said result data of result of executed one or more subtasks communicating module comprises:
a signal indicating presence of subtask result data transmitting module.

198. The system of claim 138, wherein said result data of result of executed one or more subtasks communicating module comprises:
a signal indicating one or more executed subtasks transmitting module.

199. The system of claim 138, wherein said result data of result of executed one or more subtasks communicating module comprises:
a result data of result of executed one or more subtasks broadcasting module.

200. The system of claim 138, wherein said result data of result of executed one or more subtasks communicating module comprises:
a signal indicating presence of subtask result data broadcasting module.

201. The system of claim 138, wherein said result data of result of executed one or more subtasks communicating module comprises:
a receiving transmitted signal request for subtask result data; and
a subtask result data responsive transmitting module configured to transmit subtask result data in response to receiving a transmitted signal request for subtask result data.

202. The system of claim 138, wherein said result data of result of executed one or more subtasks communicating module comprises:
a receiving broadcasted signal request for subtask result data; and
a subtask result data broadcast responsive transmitting module configured to transmit subtask result data in response to receiving a broadcasted signal request for subtask result data.

203. The system of claim 138, wherein said result data of result of executed one or more subtasks communicating module comprises:
a result data of result of executed one or more subtasks third-party retrievable repository storing module configured to the result data comprising a result of carrying out the one or more subtasks in a repository configured to allow a third party to retrieve the result data.
